(19) United States
(12) Patent Application Publication
(10) Pub. No.: US 2015/0256620 A1
(43) Pub. Date: Sep. 10, 2015

(54) INFORMATION PROCESSING APPARATUS, INFORMATION PROCESSING SYSTEM, INFORMATION PROCESSING METHOD AND RECORDING MEDIUM RECORDING INFORMATION PROCESSING PROGRAM

(71) Applicant: FUJITSU LIMITED, Kawasaki-shi (JP)

(72) Inventors: Hiroyasu Sugano, Koto (JP); Naoki Nishiguchi, Kawasaki (JP); Koichi Yokota, Yokohama (JP)

(21) Appl. No.: 14/636,530

(22) Filed: Mar. 3, 2015

(30) Foreign Application Priority Data
Mar. 4, 2014 (JP) 2014-041428

(51) Int. Cl. H04L 29/08; H04L 29/06

(52) U.S. Cl. CPC H04L 67/1095; H04L 67/40; H04L 67/06

(57) ABSTRACT

An information processing apparatus in a system which allows an access source terminal to access an electronic file held by another device, includes a storage unit that holds a processing procedure for accessing an electronic file, and a determining unit that determines an execution procedure for accessing a designated electronic file from an execution processing procedure corresponding to the processing procedure based on a size of the designated electronic file to be accessed and a state of an executing device of processing included in the processing procedure.

### CROSS-REFERENCE TO RELATED APPLICATION

This application is based upon and claims the benefit of priority of the prior Japanese Patent Application No. 2014-041428, filed on Mar. 4, 2014, the entire contents of which are incorporated herein by reference.

### FIELD

The present invention relates to an information processing apparatus in an information processing system which allows access to an electronic file stored in another device, the information processing system, an information processing method and an information processing program.

### BACKGROUND

In recent years, in accordance with spread of smart devices such as smartphones and tablet terminals, it has become a typical form in which an individual utilizes a plurality of equipment including a PC. Further, a cloud service, which stores electronic files owned by a user and allows the user to access the content regardless of the location of the user, has been widespread. Still further, a system for remotely accessing an electronic file stored in equipment at home using a smart device, or the like, is also used.

In the system for remotely accessing the electronic file stored in the equipment at home using the smart device, there is a case where a platform of the smart device is not compatible with the equipment (such as a PC) at home. For example, if the smart device is not compatible with the PC at home in terms of processing of the electronic file, it is difficult to open or edit the electronic file created on the PC using the smart device in the same way as the PC.

Therefore, there is a technique, called remote access, in which an electronic file is opened on a PC, and screen data on the PC is transmitted to a smart device so that it is possible to browse and handle the electronic file on the PC from the smart device. For example, in Windows (trademark), there is a remote desktop protocol (RDP) as service for implementing remote access.

FIG. 1 is an example of a system which allows an electronic file stored in equipment at home to be remotely accessed using a smart device. (1) When a file which can be browsed or edited at the smart device is accessed, the file is copied to the smart device, and application for browsing or editing is executed at the smart device. For example, in the example illustrated in FIG. 1, file B.pdf stored in a PC having a remote access server is copied to the smart device. A case where the file can be browsed or edited at the smart device is, for example, a case where application for browsing or editing the file is installed in the smart device.

(2) When a file which is not able to be browsed or edited at the smart device is accessed, the file is copied to a PC having a remote access server at home, if needed, and application for browsing or editing is executed at the PC. The smart device accesses the file by remotely accessing the PC having the remote access server without copying the file to the own device. In the example illustrated in FIG. 1, file A.ppt stored in the PC having the remote access server is executed on the PC and is remotely accessed by the smart device. A case where the file is not able to be browsed or edited at the smart device is, for example, a case where application for browsing or editing the file is not installed at the smart device. If virtual desktop service, or the like, is provided on the cloud, the file may be copied on the cloud, and the executed file may be remotely accessed.

(3) When the smart device accesses a file of a large size, because transferring the file to the smart device is expensive, the file is copied to a PC having a remote access server. The smart device accesses the PC through remote access, and application for browsing or editing the file is executed on the PC. While in the example illustrated in FIG. 1, the file stored in another terminal at home is copied to the PC having the remote access server, there is no need to copy the file if the file is stored in a storage of the PC in advance.

### PATENT DOCUMENT

[Patent document 1] Japanese Patent Laid-Open No. 2005-4916
[Patent document 2] Japanese Patent Laid-Open No. 10-240603

However, there are the following problems in the above-described system. For example, in any of the above-described (1) to (3), a user him/herself performs judgment as to whether or not a file needs to be copied to the smart device, designation of a device operating as the remote access server, designation of application for browsing or editing a file, or the like, which takes troubles. Further, as in the above-described (3), if the file is copied to the access server and the file is accessed through remote access, because the user performs a series of operation, such operation is trouble for the user. A series of operation is, for example, copying the file to a PC which allows remote access, activating the remote access server, activating application for browsing or editing the file, activating a remote access client of the smart device and designating remote access service for connection.

### SUMMARY

One aspect of the present invention is an information processing apparatus in a system which allows an access source terminal to access an electronic file held by another device, the information processing apparatus including a storage unit that holds a processing procedure for accessing the electric file, and a determining unit that, based on a size of a designated electronic file to be accessed and a state of an executing device of processing included in the processing procedure, determines an execution procedure for accessing the designated electronic file from an execution processing procedure corresponding to the processing procedure.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an example of a system which allows an electronic file stored in equipment at home to be remotely accessed using a smart device;

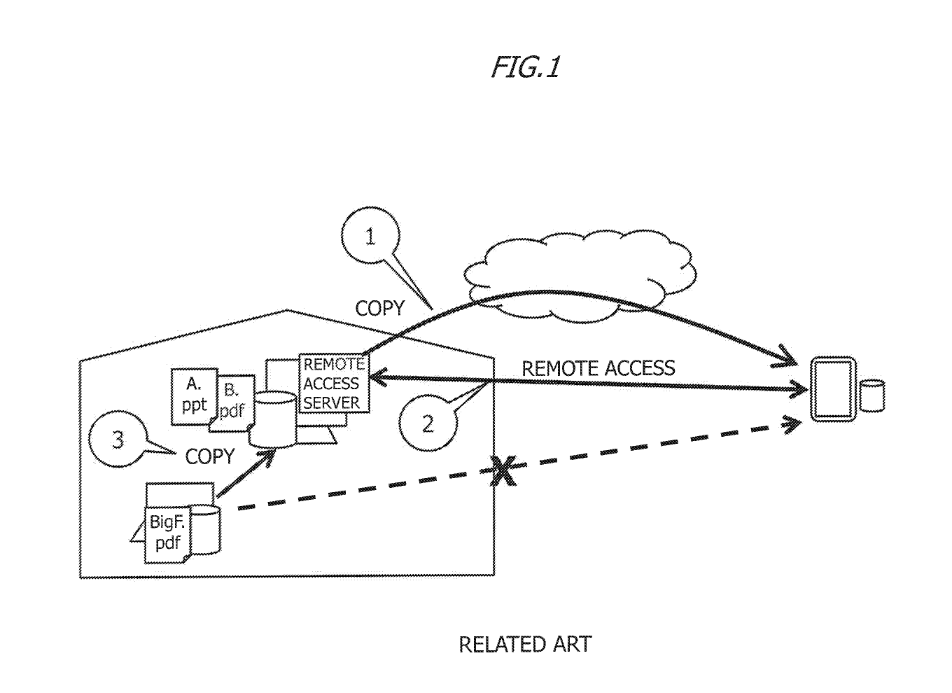

FIG. 2 is a diagram illustrating a configuration example of a remote file access system according to a first embodiment;

FIG. 3 is a diagram illustrating an example of an abstracted processing procedure and a concretized processing procedure;

FIG. 4 is a diagram illustrating an example of a hardware configuration of a server;

FIG. 5AA is a diagram illustrating an example of a functional configuration of a server in the remote file access system according to the first embodiment;

FIG. 5AB is a diagram illustrating an example of a functional configuration of each of an access source terminal and a home equipment group in the remote file access system according to the first embodiment;

FIG. 5B is an example of a user equipment relation table;

FIG. 5C is an example of an equipment information management table;

FIG. 6 is an example of the abstracted processing procedure;

FIG. 7 is an example of a processing procedure instance;

FIG. 8 is an example of evaluation formulas in the concretized processing procedure;

FIG. 9A is an example of a flowchart of processing of a processing procedure configuration managing unit;

FIG. 9B is an example of a flowchart of the processing of the processing procedure configuration managing unit;

FIG. 10A is an example of a flowchart of processing for confirming whether or not executable;

FIG. 10B is an example of a flowchart of processing for judging whether or not Action is executable;

FIG. 10C is an example of a flowchart of the processing for judging whether or not Action is executable;

FIG. 10D is an example of a flowchart of the processing for judging whether or not Action is executable;

FIG. 11A is an example of a flowchart of processing of a processing execution controlling unit;

FIG. 11B is an example of a flowchart of the processing of the processing execution controlling unit;

FIG. 12 is an example of a flowchart of file execution processing;

FIG. 13 is an example of a flowchart of file copy processing; and

FIG. 14 is an example of a flowchart of post-processing.

### DESCRIPTION OF EMBODIMENT

An embodiments of the present invention will be described below based on the drawings. Configurations in the embodiments described below are merely examples, and the present invention is not limited to the configurations in the embodiments.

### First Embodiment

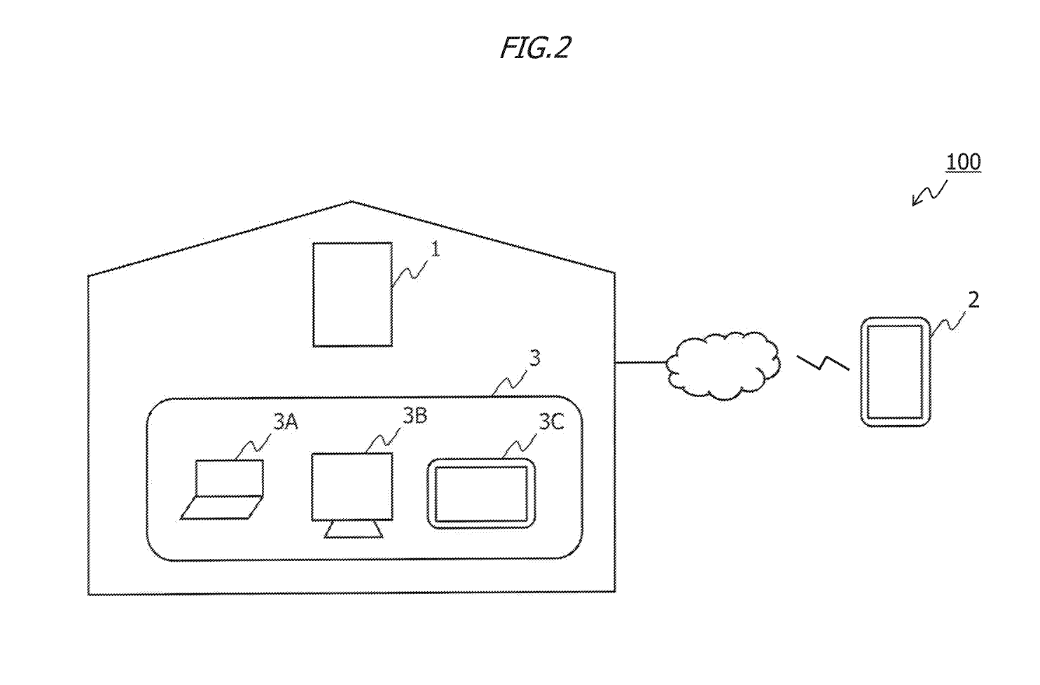

FIG. 2 is a diagram illustrating a configuration example of a remote file access system according to a first embodiment. A remote file access system. 100 includes a server 1 and an home equipment group 3 at home, and includes an access source terminal 2 outside home.

For example, the server 1 and the home equipment group 3 are connected to a LAN (Local Area Network) or a WLAN (Wireless Local Area Network), and constitutes a home network. The server 1 has functions of, for example, a web server, a remote access server and a file transfer server. The function of the file transfer server may be integrated in the web server. The home equipment group 3 includes a plurality of equipment connected to the home network, and types, functions, processing performance, or the like of the equipment included in the home equipment group 3 are different from each other. Each equipment of the home equipment group 3 has functions of a web client and a file transfer client. The function of the file transfer client may be integrated in the web client.

The access source terminal 2 has functions of, for example, a web client, a file transfer client and a remote access client. The function of the file transfer client may be integrated in the web client. The access source terminal 2 is connected from the web client to the server 1 via, for example, Internet, a LAN or a WLAN using an HTTP (Hypertext Transfer Protocol), an HTTPS (HTTP Secure), or the like. The access source terminal 2 accesses a file held in the server 1 or the equipment of the home equipment group 3 via the server 1.

The server 1 is, for example, a PC. The home equipment group 3 includes, for example, a laptop PC 3A, a desktop PC 3B, a tablet terminal 3C, and the like. Note that the server 1 may be classified into the home equipment group 3. The access source terminal 2 is, for example, a smartphone or a tablet terminal.

In the first embodiment, the server 1 holds a processing procedure for accessing a file. If a file held by the home equipment group 3 is accessed from the access source terminal 2, the server 1 determines an execution processing procedure from the processing procedure based on a size of the file to be accessed and a device which can execute processing included in the processing procedure. The processing procedure is held in an abstracted form without designating an executing device of the processing included in the processing procedure, or the like, and, when the file is accessed from the access source terminal 2, the executing device, or the like, is determined and the processing procedure is concretized. “Abstracted” refers to a state where a device to be used, application to be executed, or the like, is not individually and specifically specified. Meanwhile, “concretized” refers to a state where a device to be used, application to be executed, or the like, is individually and specifically specified. Therefore, the execution processing procedure corresponding to the processing procedure refers to a concretized processing procedure. The executing device is determined from the home equipment group 3 according to installed application, an equipment state, hardware performance, or the like. The equipment state is, for example, a state where the equipment is powered off, a state where the equipment is put into a sleep state, or a state where a user is being logged in.

Hereinafter, the processing procedure which is held in an abstracted manner is referred to as an abstracted processing procedure. Meanwhile, the execution processing procedure concretized by determining the executing device, or the like is referred to as a concretized processing procedure.

When the concretized processing procedure to be executed is determined, the server 1 requests each equipment to execute the processing according to the concretized procedure.

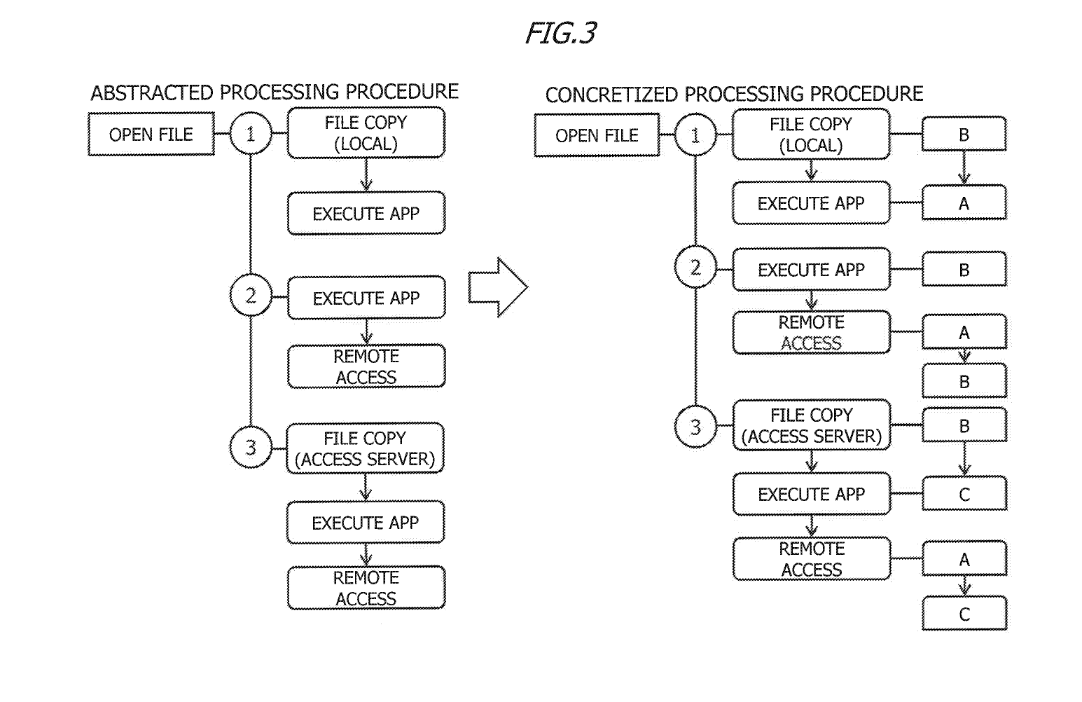

FIG. 3 illustrates examples of the abstracted processing procedure and the concretized processing procedure. When a file is browsed and edited, in common, first, action of “opening a file” is performed. The action of “opening a file” is represented in the following three types of the abstracted processing procedure using three processing of “file copy”, “application execution” and “remote access”. Here, the application execution refers to opening a file using application installed in the apparatus. Hereinafter, the application execution is abbreviated as app execution.

(Abstracted processing procedure 1) After “file copy” is performed from an access destination device to an access source terminal, “app execution” is performed at the access source terminal.
(Abstracted processing procedure 2) After “app execution” is performed at the access destination device, “remote access” is performed from the access source terminal to the access destination device. Note that, in this case, the access destination device is a remote access server.
(Abstracted processing procedure 3) After “file copy” is performed from the access destination device to a device of the remote access server, “app execution” is performed at the remote access server, and, further, “remote access” is performed from the access source terminal to the device of the remote access server.

For example, when a target file stored in a terminal B is accessed from a terminal A, that is, if the access source terminal is the terminal A and the access destination device is the terminal B, the following concretized processing procedure is obtained from the above-described abstracted processing procedure. It is assumed that the remote access server is a terminal C.

(Concretized processing procedure 1) The target file is copied from the terminal B to the terminal A, and the target file is opened using application which can execute the target file at the terminal A.
(Concretized processing procedure 2) The target file is opened using application which can execute the target file at the terminal B, and remote access is performed from the terminal A to the terminal B.
(Concretized processing procedure 3) The target file is copied from the terminal B to the terminal C, the target file is opened using application which can execute the target file at the terminal C, and remote access is performed from the terminal A to the terminal C.

The server 1 determines a procedure to be executed from the concretized processing procedure after obtaining the concretized processing procedure, and requests each device to execute the processing according to the determined concretized processing procedure.

<Apparatus Configuration>

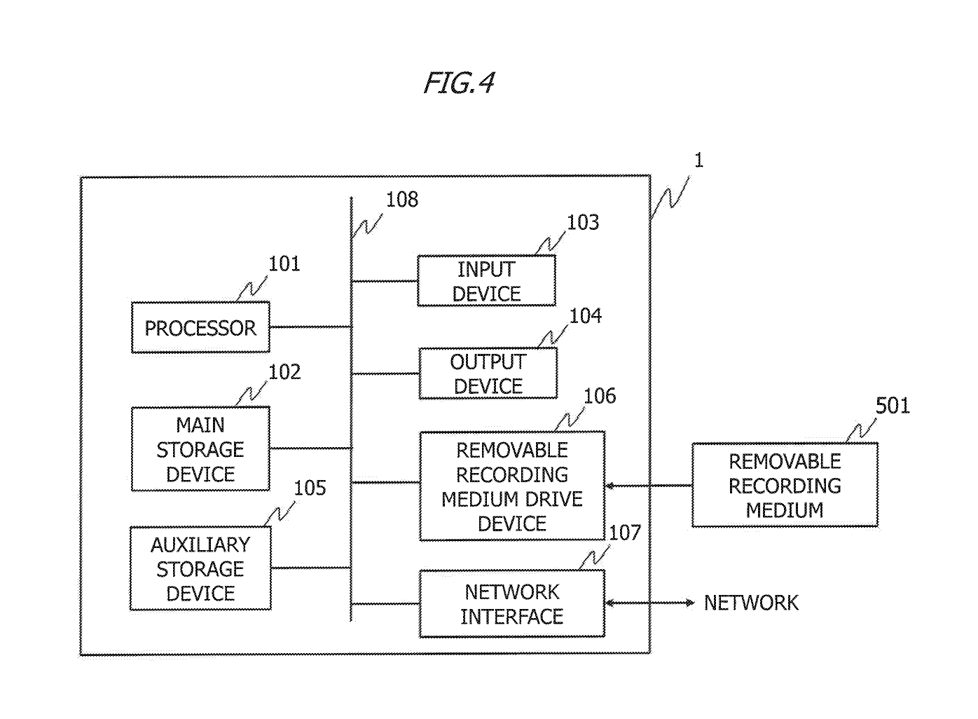

FIG. 4 is an example of a hardware configuration of the server 1. The server 1 is, for example, a general-purpose computer, or a computer dedicated for a server machine. The server 1 includes a processor 101, a main storage device 102, an input device 103, an output device 104, an auxiliary storage device 105, a removable recording medium drive device 106 and a network interface 107. These are connected to each other through a bus 108.

The input device 103 is, for example, an operation button, a touch panel, a keyboard, a keypad, or the like. Data input from the input device 103 is output to the processor 101. The input device may include an audio input device such as a microphone.

The auxiliary storage device 105 stores various programs and data used by the processor 101 for executing each program. The auxiliary storage device 105 is, for example, a non-volatile memory such as an EPROM (Erasable Programmable ROM), a flash memory and a hard disk drive. The auxiliary storage device 105 holds, for example, an operating system (OS), a processing procedure determining program, a processing procedure executing program, a web server program, a file transfer server program, a remote access server program and other various application programs. The processing procedure determining program is a program for determining a processing procedure to implement access to a file when the file under the control is accessed from a remote access executing terminal. The processing procedure executing program is a program for implementing processing instructed by a device which executes the processing procedure determining program (the server 1 in the first embodiment).

The main storage device 102 provides a storage area and a working area to which a program stored in the auxiliary storage device 105 is loaded to the processor 101, or is used as a buffer. The main storage device 102 includes, for example, a semiconductor memory such as a ROM (Read Only Memory) and a RAM (Random Access Memory).

The processor 101 is, for example, a CPU (Central Processing Unit). The processor 101 executes various processing by loading the OS and various application programs held by the auxiliary storage device 105 or the removable recording medium 501 to the main storage device 102 and executing them. The processor 101 is not limited to one, and a plurality of processors may be provided.

The removable recording medium drive device 106 reads out the program and various data recorded in the removable recording medium 501 and outputs them to the processor 101. The removable recording medium 501 is, for example, a recording medium such as a SD card, a mini SD card, a micro SD card, a USB (Universal Serial Bus) flash memory, a CD (Compact Disc), a DVD (Digital Versatile Disc), Blu-ray (trademark), Disc and a flash memory card.

The network interface 107 is an interface for inputting and outputting information from and to a network. The network interface 107 includes an interface for connecting to a wired network and an interface for connecting to a wireless network. The network interface 107 is, for example, a NIC (Network Interface Card), a wireless LAN (Local Area Network) card, or the like. Data, or the like, received at the network interface 107 is output to the processor 101.

The output device 104 outputs a result of processing of the processor 101. The output device 104 includes an audio output device such as a speaker, a display and a printer.

Note that the hardware configuration of the server 1 illustrated in FIG. 4 is merely an example, the hardware configuration is not limited to the above-described configuration, and components can be omitted, replaced or added as appropriate according to embodiments. For example, the processing procedure determining program may be recorded in the removable recording medium 501. For example, the server 1 may be a server that does not include the input device 103 and the output device 104.

Further, equipment included in the home equipment group 3 is a dedicated or general-purpose computer, whose hardware configuration is substantially the same as the configuration illustrated in FIG. 4. The equipment included in the home equipment group 3, for example, holds the processing procedure executing program at the auxiliary storage device 105. Further, the access source terminal 2 is, for example, a smart device, a laptop PC, or the like, whose hardware configuration is substantially the same as the configuration illustrated in FIG. 4, and the access source terminal 2 may include a touch panel, or the like, as the input device. The access source terminal 2 holds, for example, a remote file access program, a processing execution procedure program, remote access client application, browser application, or the like, at the auxiliary storage device 105. The remote file access program is a program for accessing a file existing within a predetermined private network such as a home network from outside.

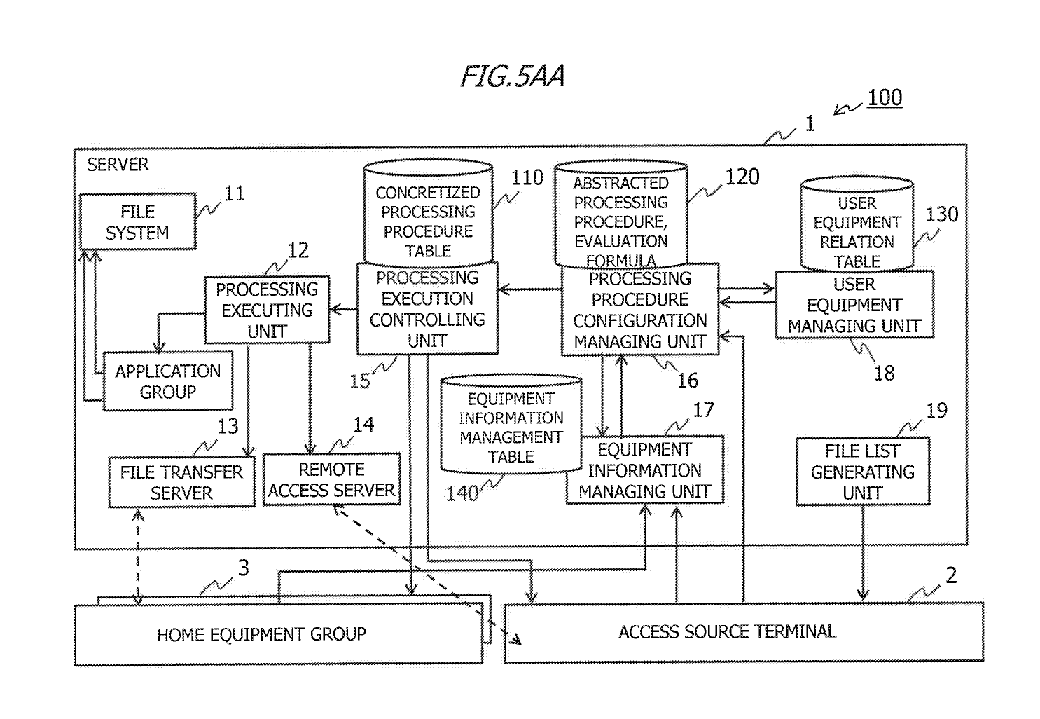

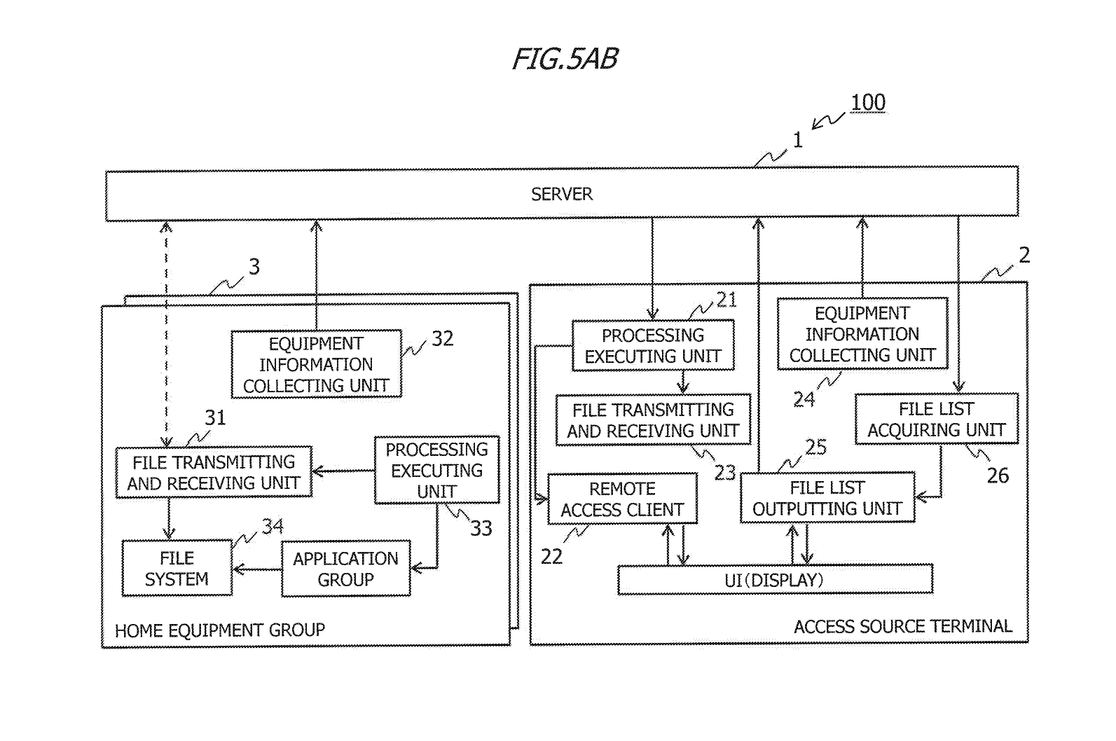

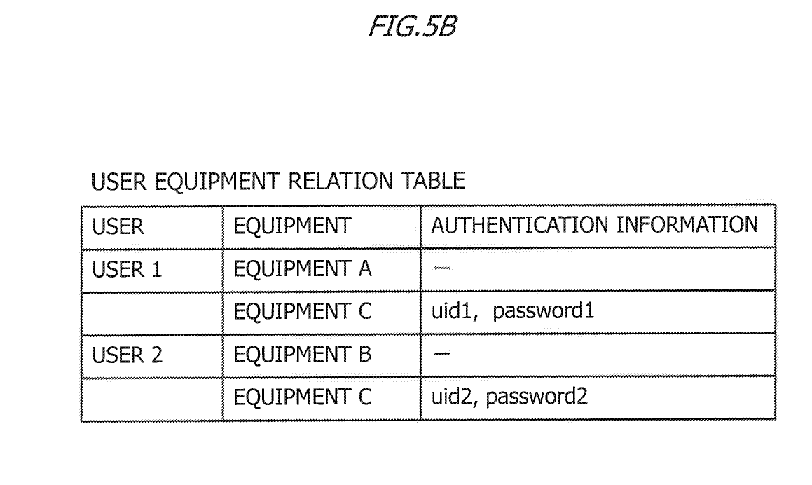

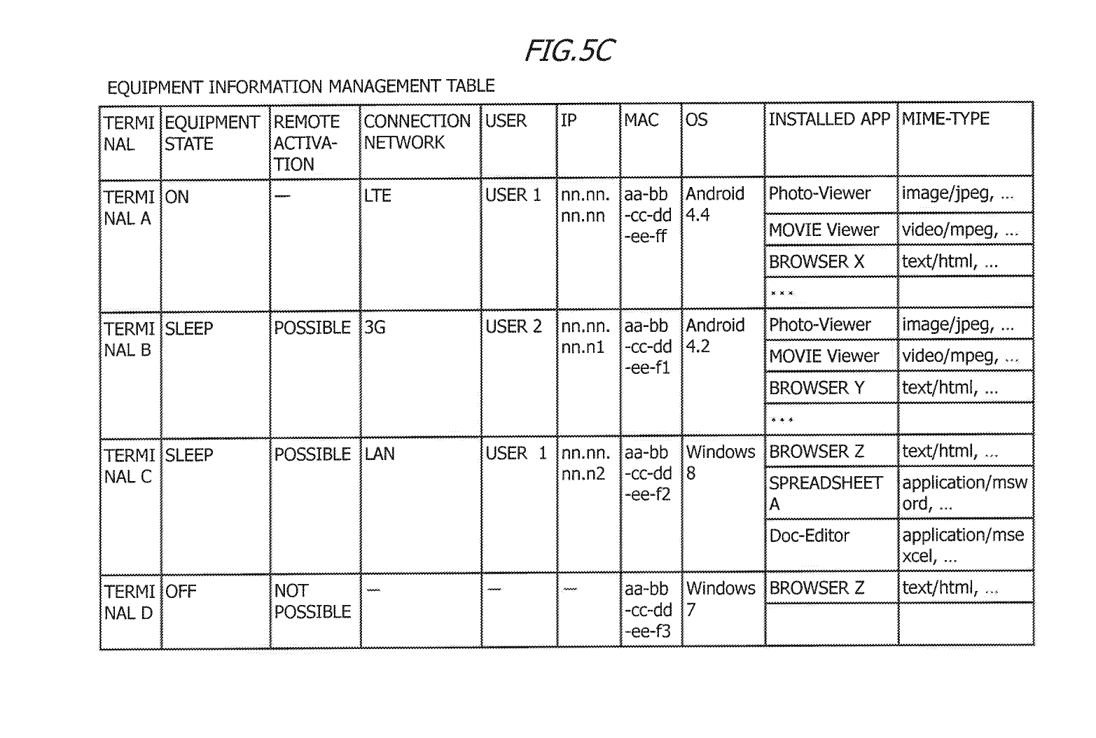

FIG. 5AA is an example of a function configuration of the server 1 in the remote file access system 100 according to the first embodiment. FIG. 5AB is a diagram illustrating an example of a functional configuration of each of an access source terminal and a home equipment group in the remote file access system according to the first embodiment.

The server 1 includes a file system 11, a processing executing unit 12, a file transfer server 13, a remote access server 14, a processing execution controlling unit 15, a processing procedure configuration managing unit 16, an equipment information managing unit 17, a user equipment managing unit 18, a file list generating unit 19, a concretized processing procedure table 110, an abstracted processing procedure table 120, a user equipment relation table 130 and an equipment information management table 140.

The concretized processing procedure table 110, the abstracted processing procedure table 120, the user equipment relation table 130 and the equipment information management table 140 are each created in, for example, a storage area of the auxiliary storage device 105. It is also possible to create these tables in a storage area of the main storage device 102.

In the abstracted processing procedure table 120, the abstracted processing procedure and an evaluation formula for evaluating the concretized processing procedure are stored. The abstracted processing procedure table 120 is an example of a “storage unit”. The abstracted processing procedure and the evaluation formula will be described in details later. In the concretized processing procedure table 110, the concretized processing procedure which has been determined to be executed is stored.

FIG. 5B is an example of the user equipment relation table 130. In the user equipment relation table 130, correspondence between identification information of a user and identification information of equipment which can be used by the user is stored. The equipment which is registered in the user equipment relation table 130 as equipment which can be used by the user is, for example, equipment used by the user as the access source terminal 2. The information stored in the user equipment relation table 130 is registered by the user or a system manager in advance. Further, the user equipment relation table 130 may have user authentication information as an option, and in the example illustrated in FIG. 5B, the user equipment relation table 130 includes the user authentication information in an item of an entry of the user equipment relation table 130.

FIG. 5C is an example of the equipment information management table 140. In the equipment information management table 140, information relating to equipment within the remote file access system 100 is stored. More specifically, in the equipment information management table 140, information relating to each equipment of the home equipment group 3, and each equipment of the access source terminal 2 and the server 1 is stored. The information relating to the equipment includes, for example, identification information of the equipment, a MAC address of the equipment, installed OS, installed software (such as an application name and the corresponding MIME type), a type of the connected network, a user who is using the equipment, a current IP address, a state of the equipment, information as to whether or not the equipment can be remotely activated, or the like. The state of the equipment which is, for example, power OFF, power ON, sleep, or the like, is one of the information for judging whether or not the corresponding equipment is available by the server 1. Further, even if the equipment is put into a sleep state or a power OFF state, if the equipment can be remotely activated, information that the equipment can be remotely activated is set as the state of the equipment. The information as to whether or not the equipment can be remotely activated depends on internal settings such as Bios of the equipment or an environment where the equipment is placed (for example, the equipment is placed inside a firewall or a NAT router and is unable to receive an activation command from outside). The information as to whether or not the equipment can be remotely activated can be known by the equipment information managing unit 17 regularly exchanging messages with the equipment, or the equipment information managing unit 17 regularly exchanging messages with a relay server on the cloud. The information stored in the equipment information management table 140 is acquired and stored by the equipment information managing unit 17 which will be described later.

Returning to FIG. 5AA, the processing execution controlling unit 15, the processing procedure configuration managing unit 16, the equipment information managing unit 17, the user equipment managing unit 18 and the file list generating unit 19 are, for example, functions implemented by the processor 101 executing the processing procedure determining program stored in the auxiliary storage device 105.

When the file stored within the remote file access system 100 is accessed from the access source terminal 2, the user equipment managing unit 18 acquires identification information of the user corresponding to the identification information of the access source terminal 2 from the user equipment relation table 130 and notifies the processing procedure configuration managing unit 16.

The file list generating unit 19 generates a list of files which are stored within the remote file access system 100 and which are accessible by the user of the access source terminal 2, according to a request from the access source terminal 2, and transmits the list to the access source terminal 2. The identification information of the user of the access source terminal 2 is transmitted from the access source terminal 2 or acquired by making an inquiry to the user equipment managing unit 18. Further, the information of the files accessible by the user of the access source terminal 2 can be acquired from each equipment by the file list generating unit 19 transmitting a retrieval command to each equipment within the remote file access system 100 using user authority of the access source terminal 2.

Alternatively, the file list generating unit 19 may have a file information table (which is not illustrated) in which identification information and storage destination information of all the files held in each equipment within the remote file access system 100 are stored. In this case, the file list generating unit 19 filters the information to be stored in the file information table using the identification information of the user of the access source terminal 2 to generate a list of files accessible by the user of the access source terminal 2. Note that the information stored in the file information table is updated by, for example, collecting the information from each equipment at a predetermined cycle.

The equipment information managing unit 17 collects the information relating to the equipment from each equipment within the remote file access system 100 and stores the information in the equipment information management table 140. For example, the equipment information managing unit 17 may collect the information relating to the equipment from each equipment by making an inquiry to each equipment at a predetermined cycle. Further, each equipment may transmit the information relating to the own equipment to the equipment information managing unit 17 of the server 1, for example, using as a trigger, a change of the information relating to the own equipment such as the state of the equipment. Further, the equipment information managing unit 17 may collect the information relating to the equipment from each equipment by making an inquiry to each equipment, using as a trigger, an inquiry from the processing procedure configuration managing unit 16 as a result of reception of a request for accessing the file from the access source terminal 2. The equipment information managing unit 17 reads out the information relating to the equipment from the equipment information management table 140 according to the inquiry from the processing procedure configuration managing unit 16.

The processing procedure configuration managing unit 16 creates a processing procedure instance by applying an actual value to the abstracted processing procedure using reception of the request for accessing the file from the access source terminal 2 as a trigger, and determines a concretized processing procedure which can be executed from the processing procedure instance based on the information relating to the equipment. The processing procedure instance is obtained by applying an actual value to the abstracted processing procedure. If there are a plurality of concretized processing procedures which can be executed, cost of each concretized processing procedure is calculated using the evaluation formula stored in the abstracted processing procedure table 120, and the concretized processing procedure to be executed is determined based on the calculated cost. The determination of the concretized processing procedure to be executed will be described in details later. The processing procedure configuration managing unit 16 notifies the processing execution controlling unit 15 of the concretized processing procedure to be executed. The processing procedure configuration managing unit 16 is an example of a “determining unit”.

The processing execution controlling unit 15 instructs the corresponding equipment to execute the corresponding processing according to the concretized processing procedure which is determined to be executed by the processing procedure configuration managing unit 16. If the access source terminal 2 or the home equipment group 3 other than the server 1 is instructed to execute the processing, a processing execution request is transmitted to the corresponding equipment over a network.

The processing executing unit 12 operates when the file accessed from the access source terminal 2 is held in the server 1. The processing executing unit 12 is, for example, a function implemented by the processor 101 executing the processing procedure executing program stored in the auxiliary storage device 105. The processing executing unit 12 sorts the instructed processing to appropriate application, or the like, according to the instruction from the processing execution controlling unit 15. For example, if activation of the remote access server is instructed from the processing execution controlling unit 15, the processing executing unit 12 activates the remote access server 14.

The file system 11 is one of the functions of the OS for managing a file held in the auxiliary storage device 105 within the server 1. The file transfer server 13 has a function of transmitting and receiving a file to and from the home equipment group 3 on the home network and the access source terminal 2. The function of the file transfer server may be performed by a web server instead. The remote access server 14 executes application on the own device and transmits image data displayed at a display of the own device to a remote access client. Communication between the remote access server 14 and the remote access client may be performed using secure communication such as, for example, SSL (Secure Sockets Layer) and VPN (Virtual Private Network).

The file transfer server 13 and the remote access server 14 are functions implemented by the processor 101 respectively executing the file transfer server program and the remote access server program. The file transfer server program includes, for example, a program which implements an FTP (File Transfer Protocol). The web server which is substituted for the file transfer server is implemented by the processor 101 executing the web server program. The web server program includes a program which implements a protocol such as an HTTP and an HTTPS. The remote access server program includes, for example, a program in which an RDP protocol is implemented.

Next, the access source terminal 2 has a processing executing unit 21, the remote access client 22, a file transmitting and receiving unit 23, an equipment information collecting unit 24, a file list outputting unit 25 and a file list acquiring unit 26.

The processing executing unit 21 is a function implemented by the processor of the access source terminal 2 executing the processing procedure executing program stored in the auxiliary storage device. The processing executing unit 21 sorts the instructed processing to appropriate application, or the like, according to the instruction from the processing execution controlling unit 15 of the server 1. For example, if remote access to the server 1 is instructed from the processing execution controlling unit 15 of the server 1, the processing executing unit 21 activates the remote access client 22 and starts remotely accessing the remote access server 14 of the server 1. For example, if copy of a target file is instructed from the processing execution controlling unit 15 of the server 1, the processing executing unit 21 instructs the file transmitting and receiving unit 23 and acquires a copy of the target file from the server 1 via the file transfer server 13 of the server 1.

The remote access client 22 and the file transmitting and receiving unit 23 are functions implemented by the processor of the access source terminal 2 executing respectively the remote access client program and the file transfer client program stored in the auxiliary storage device. For example, the remote access client program implements an RDP protocol. In the file transfer client program, for example, an FTP and an HTTP protocol are implemented.

The equipment information collecting unit 24, the file list outputting unit 25 and the file list acquiring unit 26 are functions implemented by the processor of the access source terminal 2 executing the remote file access program stored in the auxiliary storage device. The equipment information collecting unit 24 transmits information relating to the equipment of the access source terminal 2 to the server 1 according to, for example, an inquiry from the server 1 or a predetermined event occurring at the access source terminal 2. The predetermined event is, for example, upon activation of the terminal by user operation or immediately before the terminal being put into a sleep state.

The file list acquiring unit 26, for example, makes an inquiry to the file list generating unit 19 of the server 1 after the remote file access program is activated, to acquire a list of files accessible by the access source terminal 2 from the file list generating unit 19 of the server 1. The file list acquiring unit 26 outputs the acquired list of files to the file list outputting unit 25.

The file list outputting unit 25 outputs the list of files acquired by the file list acquiring unit 26 to a display. By this means, the list of files for which the user has access authority is displayed to the user of the access source terminal 2, and a file to be browsed or edited is selected by the user. The file list outputting unit 25 receives user input of selection of the file to be browsed or edited and transmits an access request to the target file to the server 1. In the access request to the file, user identification information, identification information of the target file and identification information of the equipment of the access source terminal 2 are stored.

Next, each equipment of the home equipment group 3 includes a file transmitting and receiving unit 31, an equipment information collecting unit 32, a processing executing unit 33 and a file system 34. The file system 34 is one of functions of the OS for managing the files held in the auxiliary storage device within the equipment of the home equipment group 3.

The equipment information collecting unit 32 and the processing executing unit 33 are functions implemented by the processor of the equipment of the home equipment group 3 executing the processing procedure executing program stored in the auxiliary storage device. The equipment information collecting unit 32, for example, transmits the information relating to the equipment to the server 1 at a predetermined cycle according to the inquiry from the server 1 or according to a change of a state of the own equipment.

The processing executing unit 33 is a function implemented by the processor of the equipment of the home equipment group 3 executing the processing procedure executing program stored in the auxiliary storage device. The processing executing unit 33 sorts the instructed processing to appropriate application, or the like, according to the instruction from the processing execution controlling unit 15 of the server 1. For example, if copy of the target file to the server 1 is instructed from the processing execution controlling unit 15 of the server 1, the processing executing unit 33 instructs the file transmitting and receiving unit 31 and transmits a copy of the target file to the file transfer server 13 of the server 1.

The file transmitting and receiving unit 31 is a function implemented by the processor of the equipment of the home equipment group 3 executing the file transfer client program stored in the auxiliary storage device. In the file transfer client program, a protocol such as, for example, an FTP and an HTTP is implemented.

<Example of Abstracted Processing Procedure>

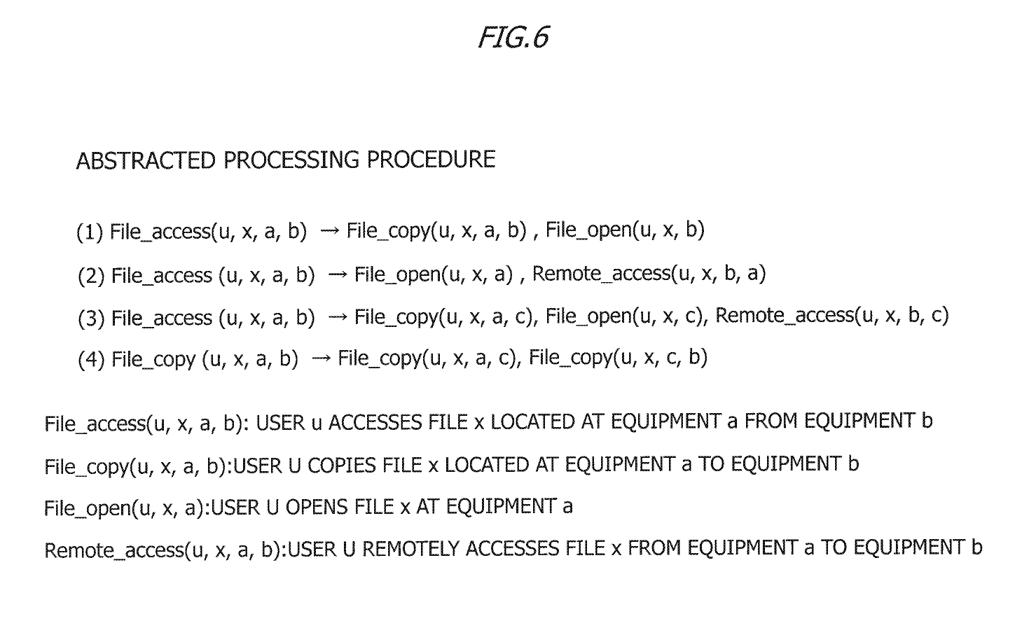

FIG. 6 is an example of the abstracted processing procedure. FIG. 6 illustrates the abstracted processing procedure relating to action of “accessing a file”. For example, the abstracted processing procedure as illustrated in FIG. 6 is stored in the abstracted processing procedure table 120.

The action of “accessing a file” includes, for example, three types of processing procedures as illustrated in FIG. 3. The three types of processing procedures of the action of “accessing a file” explained in FIG. 3 are described as illustrated in FIG. 6 in the first embodiment. Hereinafter, it is assumed that small letters of the alphabet indicate variables.

File_access(u, x, a, b) indicates that a user u accesses a file x located at equipment a from equipment b. File_copy(u, x, a, b) indicates that the user u copies the file x located at the equipment a to the equipment b. File_open (u, x, a) indicates that the user u opens the file x using application of the equipment a. Remote_access (u, x, a, b) indicates that the user u remotely accesses the file x from the equipment a to the equipment b.

File_access corresponding to the action of “accessing a file” is defined as a Goal. File_copy, File_open and Remote_access corresponding to the processing for achieving the action of “accessing a file” are defined as Actions. The Actions are executed in the order of description.

Taking into account the above-mentioned points, the abstracted processing procedure relating to the processing of “accessing a file” is described as follows in the first embodiment:

(1) File_access (u, x, a, b)→File_copy(u,x,a,b), File_open (u, x, b)

### (2)File_access(u,x,a,b)→File_open(u,x,a), Remote_access (u, x, b, a)

### (3)File_access(u,x,a,b)→File_copy(u,x,a,c), File_open(u,x,c), Remote_access(u,x,b,c)

Further, in the case of File_copy(u, x, a, b), there is a case where the file is unable to be directly copied from the equipment a to the equipment b, for example, a case where a firewall or a NAT router which blocks the network exists between the equipment a and the equipment b. In such a case, the file may be copied from the equipment a to the equipment b via a relay server c. In the processing procedure configuration managing unit 16, because it is possible to constitute the procedure for copying a file via the relay server c, the abstracted processing procedure for the constitution can be expressed as follows:

### (4)File_copy(u,x,a,b)→File_copy(u,x,a,c), File_copy(u,x,c,b)

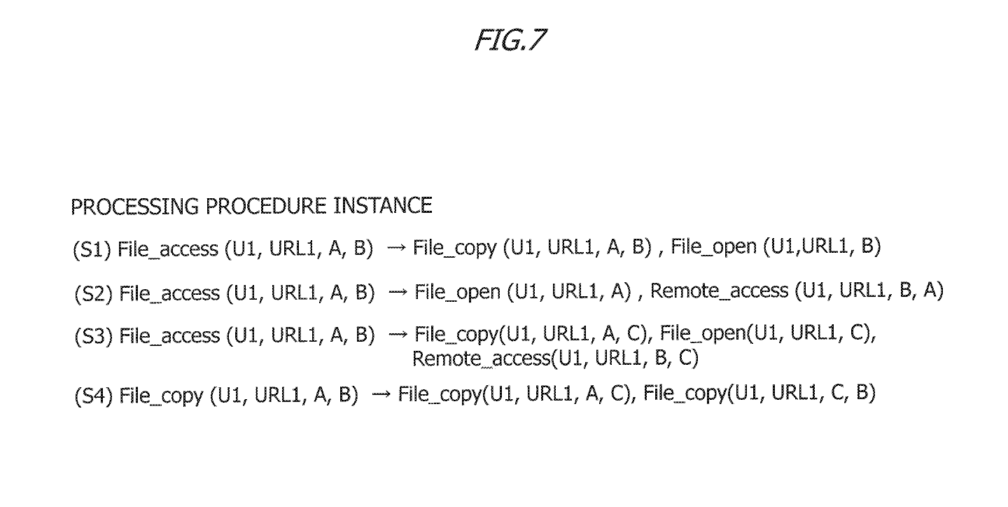

FIG. 7 is an example of the processing procedure instance. The processing procedure instance is obtained by applying an actual value to the abstracted processing procedure. The processing procedure instance illustrated in FIG. 7 is an example of one created from the abstracted processing procedure illustrated in FIG. 6. FIG. 7 illustrates an example of a case where “a user U1 opens a file URL1 on a terminal A using a terminal B”. Hereinafter, big letters of the alphabet indicate specific values (actual values). Note that a terminal C is used as a remote access server.

The processing procedure instance is created by applying actual values to the variables of the abstracted processing procedure. In the example illustrated in FIG. 7, the processing procedure instance created by applying the user U1, the file URL1, the terminal A, the terminal B and the terminal C respectively to the user u, the file x, the equipment a, the equipment b and the equipment c of the abstracted processing procedure illustrated in FIG. 6 is illustrated. The processing procedure instance in the example illustrated in FIG. 7 is as follows.

### (S1)File_access(U1,URL1,A,B)→File_copy(U1,URL1,A,B), File_open(U1,URL1,B)

### (S2) File_access(U1,URL1,A,B)→File_open(U1,URL1,A), Remote_access(U1,URL1,B,A)

(S3)File_access(U1,URL1,A,B)→File_copy(U1,URL1,A,C), File_open(U1,URL1,C), Remote_access(U1,URL1,B,C)

### (S4)File_copy(U1,URL1,A,B)→File_copy(U1,URL1,A,C), File_copy(U1,URL1,C,B)

The description form of the processing procedure instance can be expressed as follow (i and n are positive integral numbers):

### Si: Goal→Action_i_{—}1, . . . , Action_i_ni

In the case of the example illustrated in FIG. 7, a variable i is 1≦i≦4. A variable ni is 1≦ni≦the number of Actions included in each instance.

Hereinafter, a right side of the executable processing procedure instance (that is, a portion except the Goal) will be referred to as a concretized processing procedure. Whether or not the processing procedure instance can be executed is judged through processing for confirming whether or not executable, which will be described later.

<Example of Evaluation Formula>

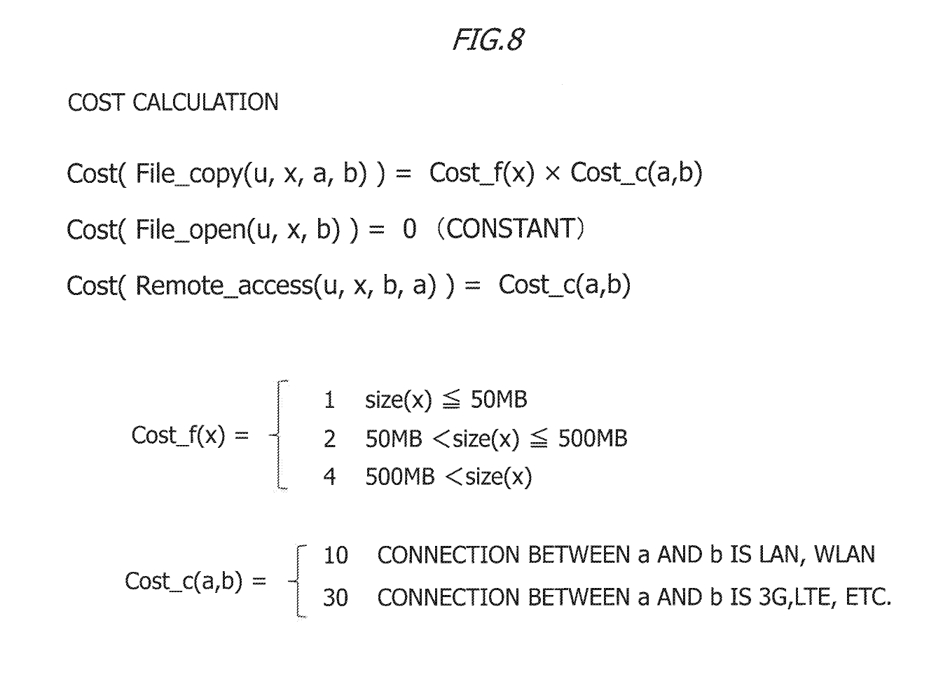

FIG. 8 is an example of an evaluation formula of the concretized processing procedure. The evaluation formula is a formula for obtaining cost of the concretized processing procedure. The evaluation formula is used to determine the concretized processing procedure to be executed if there are a plurality of executable concretized processing procedures.

When the file is remotely accessed, a size of the file, line speed, or the like become factors for determining execution of file copy to the access source terminal 2 and remote access. Therefore, the cost of the concretized processing procedure is determined according to the size of the file and types of the lines. Further, as previously described, because the concretized processing procedure is a collection of a plurality of Actions, in the first embodiment, cost is obtained for each Action, and a sum of the cost of the Actions becomes the cost of the concretized processing procedure.

First, a cost Cost(File_copy(u, x, a, b)) of File_copy (u, x, a, b) is obtained from Cost_f(x)×Cost_c(a, b). A cost Cost(File_open(u, x, b)) of File_open(u, x, b) is 0. A cost Cost(Remote_access (u, x, b, a)) of Remote_access(u, x, b) is obtained from Cost_c(a, b).

Cost_f(x) indicates cost of the file x. For example, the cost of the file x is determined according to the size of the file. In the first embodiment, if the size of the file x is 50 M bytes or smaller, Cost_f(x) is 1. If the size of the file x is larger than 50 M bytes and 500 Mbytes or smaller, Cost_f(x) is 2. If the size of the file x is larger than 500 Mbytes, Cost_f(x) is 4. size(x) in FIG. 8 indicates the size of the file x.

Cost_c(a, b) indicates cost of connection between the equipment a and the equipment b. In the first embodiment, if the connection between the equipment a and the equipment b is a LAN or a WLAN, Cost_c(a, b) is 10. If the connection between the equipment a and the equipment b is 3G, LTE, or the like, Cost_c(a, b) is 30.

In the first embodiment, the concretized processing procedure with the lowest cost is determined as the concretized processing procedure to be executed. Note that the evaluation formula of the concretized processing procedure is not limited to the example illustrated in FIG. 8, and may be set according to the configuration of the system, or the like. Hereinafter, application of a specific value to the variables of the abstracted processing procedure will be referred to as instantiation.

<Flow of Processing>

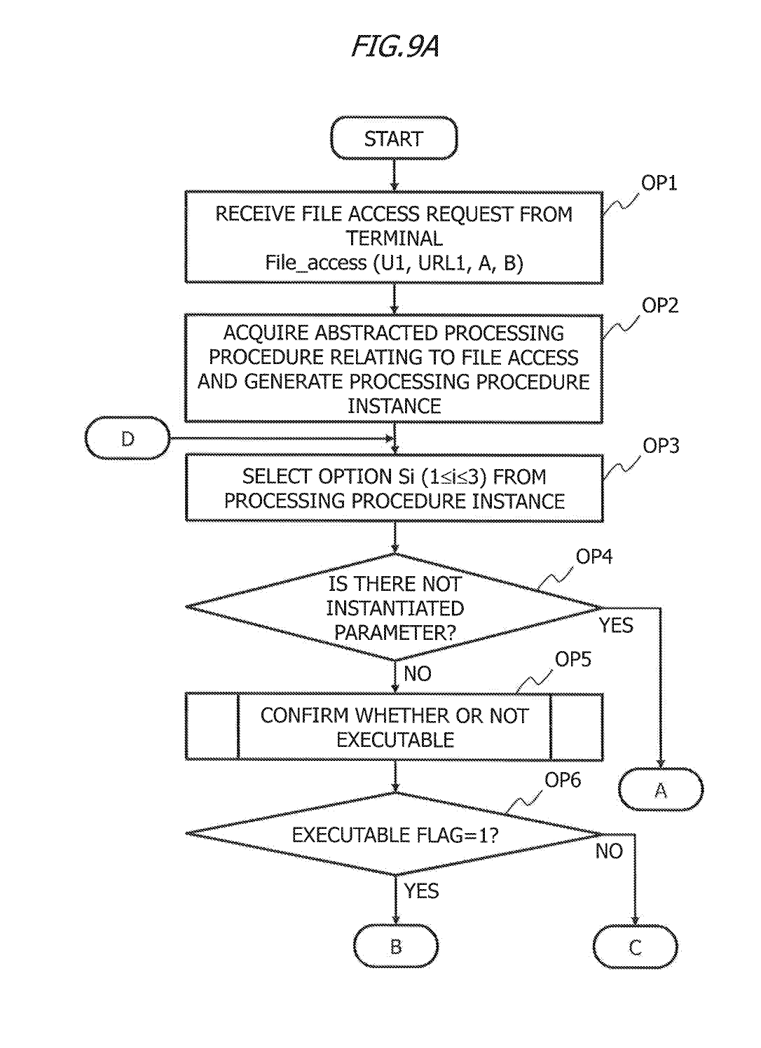

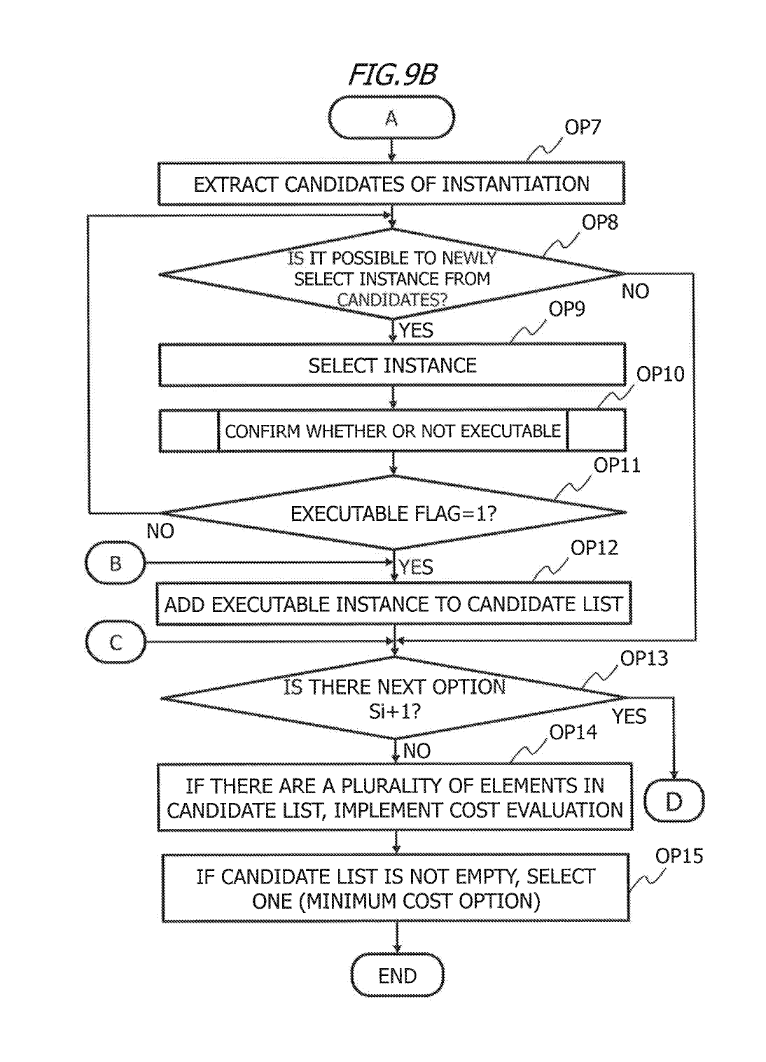

FIG. 9A and FIG. 9B are examples of flowcharts of the processing of the processing procedure configuration managing unit 16. The flowcharts illustrated in FIG. 9A and FIG. 9B, for example, start upon activation of the server 1 and are repeatedly implemented during activation of the server 1.

In OP1, the processing procedure configuration managing unit 16 receives an access request for a file from the access source terminal 2. In the access request, at least identification information of the equipment of the access source terminal 2 and identification information of the file to be accessed are stored. Note that the information included in the access request is not limited to these, and the access request may include user identification information, storage destination equipment of the file to be accessed, a file size, and the like.

If information such as the user identification information, the storage destination equipment of the file to be accessed and the file size is not included in the access request, the processing procedure configuration managing unit 16 acquires these values by referring to each table. Specifically, the processing procedure configuration managing unit 16 acquires the identification information of the user of the access source terminal 2 associated with the identification information of the equipment of the access source terminal 2 from the user equipment relation table 130. The processing procedure configuration managing unit 16 makes an inquiry to the file list generating unit 19 to acquire the storage destination and the file size of the file to be accessed.

Hereinafter, it is assumed in the examples illustrated in FIG. 9A and FIG. 9B that a user U1, a URL1 which is the identification information of the file, equipment A which is the storage destination of the file, and equipment B which is the access source terminal 2 are respectively acquired as the user u, the file x, the equipment a and the equipment b, which are variables, in the abstracted processing procedure. Subsequently, the processing proceeds to OP2.

In OP2, the processing procedure configuration managing unit 16 acquires the abstracted processing procedure relating to the file access from the abstracted processing procedure table 120 and generates a processing procedure instance. For example, if the user U1, the file URL1, the equipment A and the equipment B are acquired as variables in OP1, the processing procedure instance illustrated in FIG. 7 is generated by applying these values to the variables in the abstracted processing procedure illustrated in FIG. 6. Subsequently, the processing proceeds to OP3.

In OP3, the processing procedure configuration managing unit 16 selects a processing procedure instance Si. An initial value of i is 1. Further, if, for example, the processing procedure instance Si illustrated in FIG. 7 is used, the variable i takes a value of 1≦i≦3. Because a processing procedure instance S4 illustrated in FIG. 7 is accessorily used in the Action of File_copy of the processing procedure instances S1 and S3, the processing procedure instance S4 is not included in the number of the processing procedure instances here. Subsequently, the processing proceeds to OP4.

In OP4, the processing procedure configuration managing unit 16 judges whether or not there is a variable which is not instantiated among the selected processing procedure instance Si. The variable which is not instantiated indicates a variable for which an actual value to be applied to the variable is not determined. If there is a variable which is not instantiated (OP4: Yes), the processing proceeds to OP7. If specific values are applied to all the variables (OP4: No), the processing proceeds to OP5.

In OP5, the processing procedure configuration managing unit 16 executes processing for confirming whether or not executable for judging whether or not the processing procedure instance Si is executable. The processing for confirming whether or not executable will be described in details later. If the processing for confirming whether or not executable is finished, subsequently, the processing proceeds to OP6.

In OP6, the processing procedure configuration managing unit 16 judges whether or not an executable flag is 1. The executable flag indicates a result of the processing for confirming whether or not executable in OP5 for the processing procedure instance Si. For example, a case where the executable flag is 1 indicates that the processing procedure instance Si is executable. A case where the executable flag is 0 indicates that the processing procedure instance Si is not executable. If the executable flag is 1 (OP6: Yes), the processing proceeds to OP12. If the executable flag is 0 (OP6: No), the processing proceeds to OP13.

In OP7, because there is a variable which is not instantiated among the selected processing procedure instance Si, the processing procedure configuration managing unit 16 extracts a list of candidate equipment which is a candidate to be applied to the variable which is not instantiated. For example, in the case of the processing procedure instance S3 illustrated in FIG. 7, the terminal C which operates as a remote access server of Remote_access(U1, URL1, B, C) is not instantiated when the user U1, the URL1, the equipment A and the equipment B are instantiated, and the processing of OP7 is executed. Subsequently, the processing proceeds to OP8.

In OP8, the processing procedure configuration managing unit 16 judges whether or not the equipment can be newly selected among the list of candidate equipment extracted in OP7, that is, whether or not the list of the candidate equipment is empty. If there is equipment which can be newly selected among the candidate equipment list (OP8: Yes), the processing proceeds to OP9. If there is no equipment which can be newly selected among the list of candidate equipment, that is, if the list of candidate equipment is empty (OP8: No), the processing proceeds to OP13.

In OP9, the processing procedure configuration managing unit 16 selects equipment to be actually applied to a variable among the list of candidate equipment extracted in OP7 and deletes the selected equipment from the list of candidate equipment. Subsequently, the processing proceeds to OP10.

In OP10, the processing procedure configuration managing unit 16 executes processing for confirming whether or not executable for judging whether or not the processing procedure instance Si is executable. The processing for confirming whether or not executable will be described in details later. If the processing for confirming whether or not executable is finished, subsequently, the processing proceeds to OP11.

In OP11, the processing procedure configuration managing unit 16 judges whether or not the executable flag is 1. If the executable flag is 1 (OP11: Yes), the processing proceeds to OP12. If the executable flag is 0 (OP11: No), the processing proceeds to OP8, and the processing from OP8 to OP11 is executed for the candidate equipment to be applied to the subsequent variable.

In OP12, the processing procedure configuration managing unit 16 generates a concretized processing procedure from an executable processing procedure instance, that is, a processing procedure instance whose executable flag is 1, and adds the executable processing procedure instance to the list of candidates. Subsequently, the processing proceeds to OP13.

In OP13, the processing procedure configuration managing unit 16 judges whether or not there is a processing procedure instance Si+1 which is the next option. If there is a processing procedure instance Si+1 which is the next option (OP13: Yes), the processing returns to OP3, and the processing from OP3 to OP12 is repeatedly executed for the next processing procedure instance Si+1. If there is no unprocessed processing procedure instance Si+1 which is the next option (OP13: No), the processing proceeds to OP14.

In OP14, if there are a plurality of concretized processing procedures in the list of candidates, the processing procedure configuration managing unit 16 calculates cost for each concretized processing procedure according to, for example, the evaluation formula illustrated in FIG. 8. If there is one concretized processing procedure in the list of candidates, the processing of OP14 is not executed. Subsequently, the processing proceeds to OP15.

In OP15, the processing procedure configuration managing unit 16 selects a concretized processing procedure to be executed from the concretized processing procedures within the list of candidates. If the cost is calculated in OP14, the processing procedure configuration managing unit 16 selects a concretized processing procedure with the smallest cost as the concretized processing procedure to be executed. The selected concretized processing procedure is output to the processing execution controlling unit 15. Then, the processing illustrated in FIG. 9A and FIG. 9B is finished.

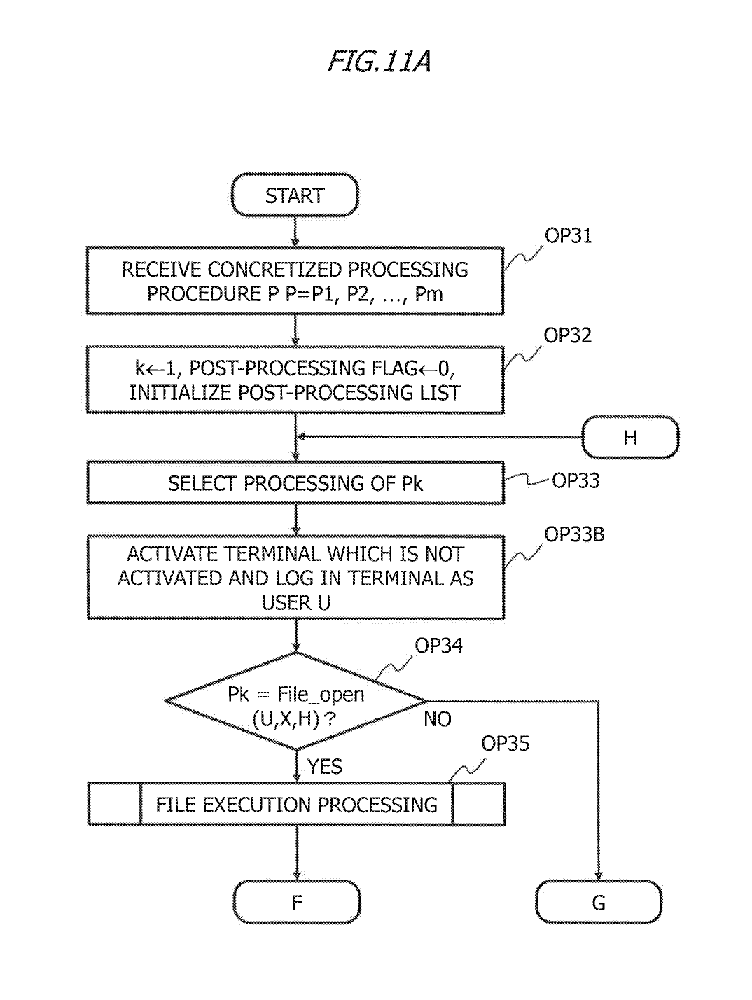

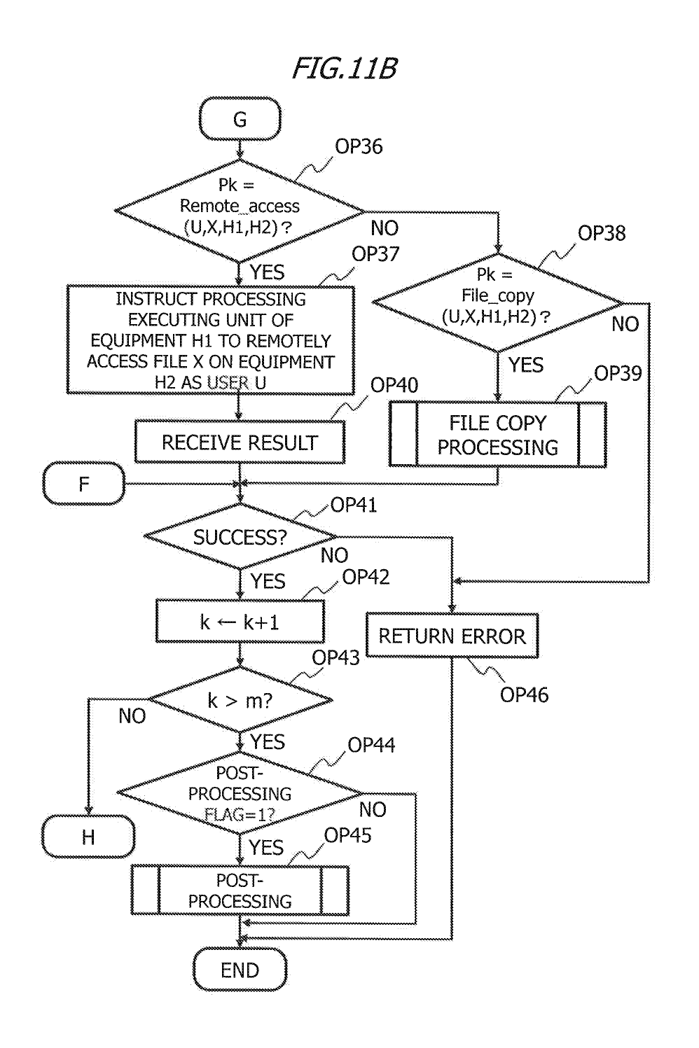

Hereinafter, the processing execution controlling unit 15 instructs the equipment to execute the processing according to the concretized processing procedure. The processing of the processing execution controlling unit 15 will be described later in FIG. 11A and FIG. 11B.

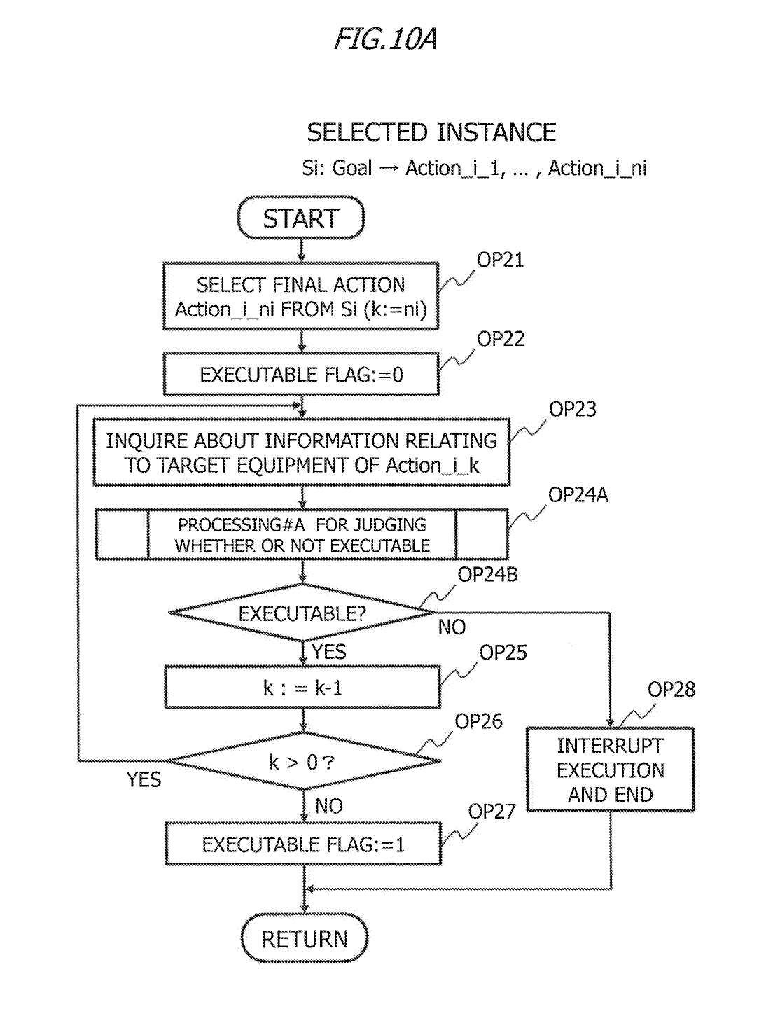

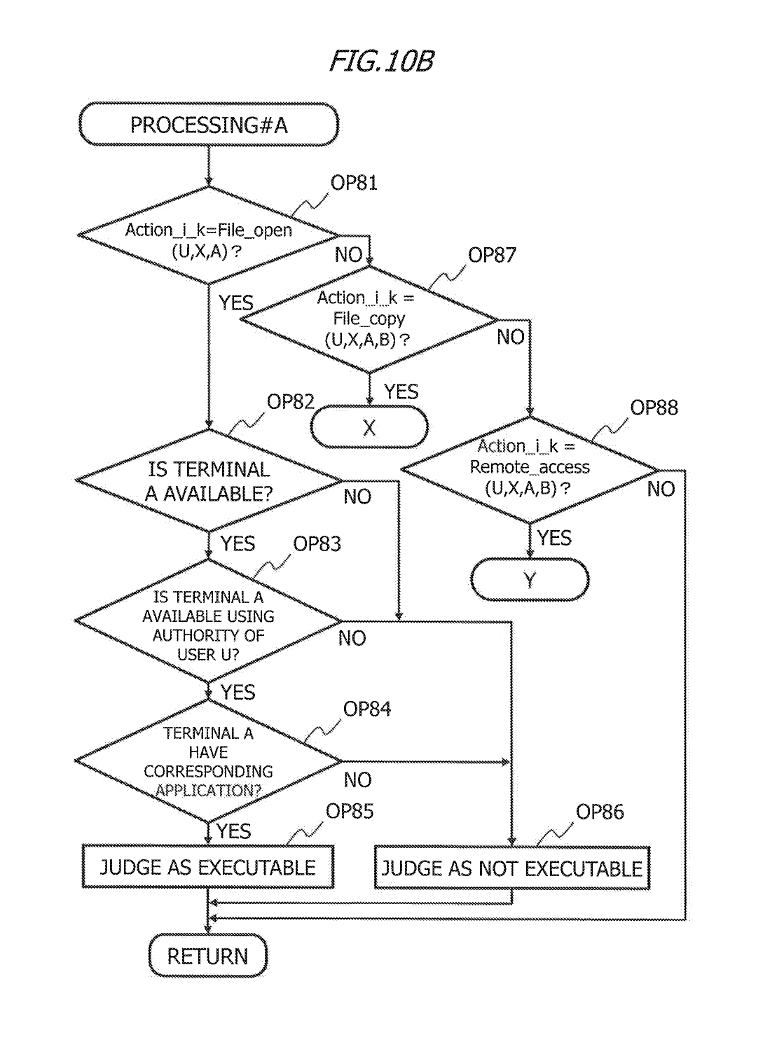

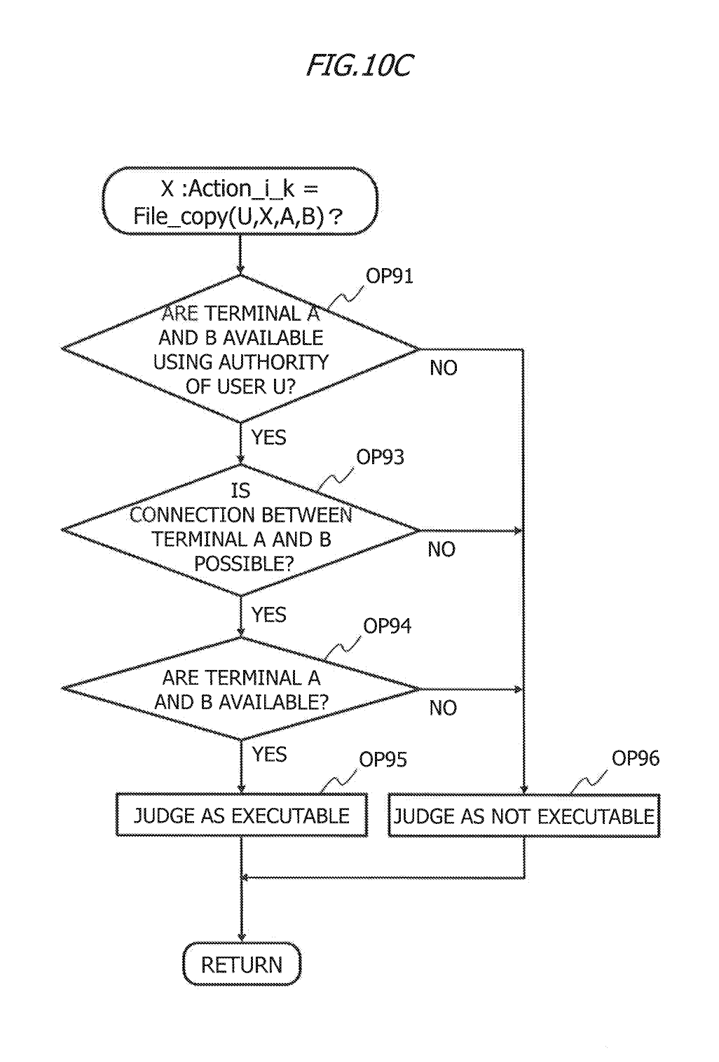

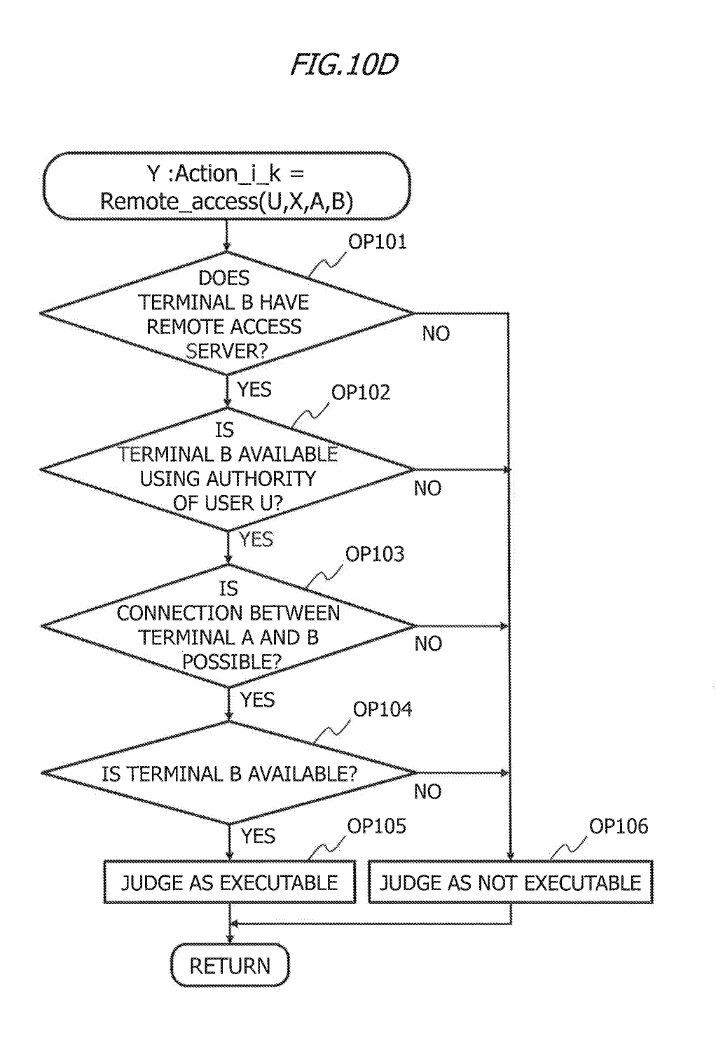

FIG. 10A is an example of a flowchart of the processing for confirming whether or not executable. The processing for confirming whether or not executable is, for example, processing for judging whether or not the processing procedure instance Si selected in the processing of OP3 in FIG. 9A is executable. The form of the processing procedure instance Si is as described above. (Si:Goal→Action_i_{—}1, . . . , Action_i_ni)

In OP21, the processing procedure configuration managing unit 16 selects a final action Action_i_ni from the processing procedure instance Si. Further, a variable k is set as k=ni. Subsequently, the processing proceeds to OP22.

In OP22, the processing procedure configuration managing unit 16 sets 0 for an executable flag of the processing procedure instance Si. Subsequently, the processing proceeds to OP23.

In OP23, the processing procedure configuration managing unit 16 acquires information relating to a target equipment of Action_i_k by making an inquiry to the equipment information managing unit 17. In the case of File_copy(U1, URL1, A, B), the target equipment is the terminal A and the terminal B. In the case of File_open(U1, URL1, B), the target equipment is the terminal B. In the case of Remote_access (U1, URL1, B, C), the target equipment is the terminal B and the terminal C. Subsequently, the processing proceeds to OP24A.

In OP24A, the processing procedure configuration managing unit 16 performs processing for judging whether or not Action is executable for judging whether or not Action_i_k is executable. The processing for judging whether or not Action is executable will be described in details later.

If Action_i_k is judged as executable (OP24B: Yes), the processing proceeds to OP25. In OP25, the processing procedure configuration managing unit 16 sets k-1 for the variable k. Subsequently, the processing proceeds to OP26.

In OP26, the processing procedure configuration managing unit 16 judges whether or not the variable k is a positive value. If the variable k is a positive value (OP26: Yes), because there remains Action for which it has not been judged whether or not Action is executable in the processing procedure instance Si, the processing returns to OP23, and it is judged whether or not Action is executable for the next Action.

If the variable k is not a positive value (OP26: No), the processing proceeds to OP27. In OP27, because it has been judged that Action is executable for all Actions included in the processing procedure instance Si, the processing procedure configuration managing unit 16 sets 1 for the executable flag. Then, the processing for judging whether or not executable for the processing procedure instance Si illustrated in FIG. 10A is finished, and the processing proceeds to OP6 in FIG. 9A or OP11 in FIG. 9B.

In OP24B, if it has been judged that Action_i_k is not executable (OP24B: No), the processing proceeds to OP28. In OP28, if even one Action which is not executable is included, because the processing procedure instance Si is not executable, the processing procedure configuration managing unit 16 interrupts execution of the processing for judging whether or not executable for the processing procedure instance Si. Therefore, in this case, the executable flag of the processing procedure instance Si is 0. Then, the processing for judging whether or not executable for the processing procedure instance Si illustrated in FIG. 10A is finished, and the processing proceeds to OP6 in FIG. 9A or OP11 in FIG. 9B.

FIG. 10B, FIG. 10C and FIG. 10D are examples of flowcharts of the processing for judging whether or not Action is executable. The processing for judging whether or not Action is executable is, for example, processing for judging whether or not Action_i_k selected in the processing of OP21 in FIG. 10A is executable. Note that the user U, the file X, the terminal A, and the terminal B used in the explanation of FIG. 10B, FIG. 10C and FIG. 10D are used for generalized explanation, and are not limited to a given user, file, terminal, or the like.

If Action_i_k is File_open (U, X, A) (OP81: Yes), the processing proceeds to OP82. If Action_i_k is File_copy(U, X, A, B) (OP87: Yes), the processing proceeds to OP91. If Action_i_k is Remote_Access(U, X, A, B) (OP88: Yes), the processing proceeds to OP101. If Action_i_k is none of the above (OP88: No), the processing illustrated in FIG. 10B is finished.

The processing from OP82 to OP86 is processing in a case where Action_i_k is File_open (U, X, A). In OP82, the processing procedure configuration managing unit 16 judges whether or not the terminal A can be used. The terminal A may be a device operating as a remote access server, other than the access source terminal 2. Therefore, first, the state of the terminal A is confirmed. A state where the terminal A can be used is a state where the terminal A is powered ON, or the terminal A can be remotely activated even if the terminal A is powered OFF or is put into a sleep state. This judgment is performed based on the equipment information management table 140.

If the terminal A can be used (OP82: Yes), the processing proceeds to OP83. If the terminal A is not able to be used (OP82: No), the processing proceeds to OP86.

In OP83, the processing procedure configuration managing unit 16 judges whether or not the terminal A can be used using authority of the user U at the present moment. Whether or not the terminal A can be used using authority of the user U is judged by making an inquiry to the user equipment relation table 130 and the equipment information management table 140. For example, it is assumed that if the terminal A is included in the equipment which can be used by the user U and a current user is not a user other than the user U, the terminal A can be used using the authority of the user U.

If the file X on the terminal A is available using the authority of the user U at the present moment (OP83: Yes), the processing proceeds to OP84. If the file X on the terminal A is not available using the authority of the user U at the present moment (OP83: No), the processing proceeds to OP86.

In OP84, the processing procedure configuration managing unit 16 judges whether or not application which can execute the file X is installed in the terminal A. This judgment is performed according to, for example, whether a MIME type corresponding to the file X is acquired from data (not illustrated) managing correspondence relationship between a file extension of the file X and a MIME type managed by a web server (the server 1 in the first embodiment) and whether or not there is correspondence between application which can process the corresponding MIME type and the terminal A in the equipment information management table 140.

If application which can execute the file X is installed in the terminal A (OP84: Yes), the processing proceeds to OP85. In OP85, the processing procedure configuration managing unit 16 judges that Action_i_k is executable. Then, the processing for judging whether or not Action is executable for Action_i_k is finished.

If application which can execute the file X is not installed in the terminal A (OP84: No), the processing proceeds to OP86.

In OP86, because the terminal A is not able to be used, or the file X on the terminal A is not available using the authority of the user U at the present moment, or application which can execute the file X is not installed in the terminal A, the processing procedure configuration managing unit 16 judges that Action_i_k is not executable. Then, the processing for judging whether or not Action is executable for Action_i_k is finished.

Note that the order of executing the judgment processing of OP82, OP83 and OP84 is not limited to the example illustrated in FIG. 10B, and the processing may begin with any of OP82, OP83 and OP84.

The processing from OP91 to OP96 is processing in a case where Action_i_k is File_copy(U, X, A, B). In OP91, the processing procedure configuration managing unit 16 judges whether or not the terminal A and the terminal B can be used using the authority of the user U at the present moment. This judgment is performed in a similar manner to OP83 based on the user equipment relation table 130, the equipment information management table 140, and the user identification information included in the access request.

If the terminal A and the terminal B can be used using the user authority of the user U (OP91: Yes), the processing proceeds to OP93. If the terminal A and the terminal B are not able to be used using the user authority of the user U (OP91: No), the processing proceeds to OP96.

In OP93, the processing procedure configuration managing unit 16 judges whether or not connection between the terminal A and the terminal B can be secured in a state where file copy is possible. For example, the processing procedure configuration managing unit 16 acquires connection networks of the terminal A and the terminal B based on the equipment information management table 140 and confirms interconnectivity between the connection networks.

If the connection between the terminal A and the terminal B can be secured in a state where file copy is possible (OP93: Yes), the processing proceeds to OP94. If the connection between the terminal A and the terminal B is not able to be secured in a state where file copy is possible (OP93: No), the processing proceeds to OP96.

In OP94, the processing procedure configuration managing unit 16 judges whether or not the terminal A and the terminal B can be used. This judgment is performed based on the equipment information management table 140.

If the terminal A and the terminal B can be used (OP94: Yes), the processing proceeds to OP95. In OP95, the processing procedure configuration managing unit 16 judges that Action_i_k is executable. Then, the processing for judging whether or not Action is executable for Action_i_k is finished.

If the terminal A and the terminal B are not able to be used (OP94: No), the processing proceeds to OP96. In OP96, because the terminal A and the terminal B are not able to be used using the user authority of the user U, or the connection between the terminal A and the terminal B is not able to be secured, or the terminal A and the terminal B are not able to be used, the processing procedure configuration managing unit 16 judges that Action_i_k is not executable. Then, the processing for judging whether or not Action is executable for Action_i_k is finished.

Note that the order of executing the judgment processing from OP91 to OP94 is not limited to the example illustrated in FIG. 10C, and the processing may begin with any of the processing.

The processing from OP101 to OP106 is processing in a case where Action_i_k is Remote_access (U, X, A, B). In OP101, the processing procedure configuration managing unit 16 judges whether or not the terminal B has a remote access server. This judgment is performed, for example, based on the equipment information management table 140.

If the terminal B has a remote access server (OP101: Yes), the processing proceeds to OP102. If the terminal B does not have a remote access server (OP101: No), the processing proceeds to OP106.

In OP102, the processing procedure configuration managing unit 16 judges whether or not the terminal B can be used using the authority of the user U at the present moment. The judgment as to whether or not the terminal B can be used using the authority of the user U is performed in a similar manner to OP83 based on the user equipment relation table 130, the equipment information management table 140, and the user identification information included in the access request.

If the file X on the terminal B is available using the authority of the user U at the present moment (OP102: Yes), the processing proceeds to OP103. If the file X on the terminal B is not available using the authority of the user U at the present moment (OP102: No), the processing proceeds to OP106.

In OP103, the processing procedure configuration managing unit 16 judges whether or not connection is possible from the terminal A to the terminal B using a remote access protocol. For example, the processing procedure configuration managing unit 16 acquires connection networks of the terminal A and the terminal B based on the equipment information management table 140 and confirms interconnectivity between the connection networks.

If connection from the terminal A to the terminal B is possible using a remote access protocol (OP103: Yes), the processing proceeds to OP104. If connection from the terminal A to the terminal B is not possible using a remote access protocol (OP103: No), the processing proceeds to OP106.

In OP104, the processing procedure configuration managing unit 16 judges whether or not the terminal B can be used. This judgment is performed based on the equipment information management table 140.

If the terminal B can be used (OP104: Yes), the processing proceeds to OP105. In OP105, the processing procedure configuration managing unit 16 judges that Action_i_k is executable. Then, the processing for judging whether or not Action is executable for Action_i_k is finished.

If the terminal B is not able to be used (OP104: No), the processing proceeds to OP106. In OP106, because the terminal B does not have a remote access server, or the terminal B is not able to be used using the authority of the user U at the present moment, or the connection from the terminal A to the terminal B is not possible using a remote access protocol, or the terminal B is not able to be used, the processing procedure configuration managing unit 16 judges that Action_i_k is not executable. Then, the processing for judging whether or not Action is executable for Action_i_k is finished.

Note that the order of executing the judgment processing from OP101 to OP104 is not limited to the example illustrated in FIG. 10D, and the processing may begin with any processing.

FIG. 11A and FIG. 11B are examples of flowcharts of the processing of the processing execution controlling unit 15. The processing illustrated in FIG. 11A and FIG. 11B starts along with activation of the server 1 and is repeatedly executed during activation of the server 1. In FIG. 11A and FIG. 11B, the concretized processing procedure P is represented as P1, P2, . . . , Pm. P1, P2, . . . , Pm correspond to Actions in the processing procedure instance. m is the number of processing (Actions) included in the concretized processing procedure.

In OP31, the processing execution controlling unit 15, for example, receives the concretized processing procedure P determined by executing the processing in FIG. 9A and FIG. 9B from the processing procedure configuration managing unit 16. Subsequently, the processing proceeds to OP32.

In OP32, the processing execution controlling unit 15 sets 1 for the variable k. Further, the processing execution controlling unit 15 sets 0 for a post-processing flag, and sets an empty list for a post-processing list. The post-processing flag is a flag indicating a possibility that post-processing for performing write-back for reflecting edited content to an original file is performed when the copied file is edited after file copy. Further, the post-processing list is a list in which the concretized processing procedure of the post-processing which may be executed when the file copy is executed is stored. Subsequently, the processing proceeds to OP33.

In OP33, the processing execution controlling unit 15 selects the processing of Pk from the processing P1, P2, . . . , Pm included in the concretized processing procedure P. Subsequently, the processing proceeds to OP33B.

In OP33B, the processing execution controlling unit 15 acquires a state of equipment included in the processing Pk from the equipment information managing unit 17, and, if the equipment is not activated, activates the corresponding equipment. Further, if the corresponding equipment is not logged in by a user included in the processing Pk, the processing execution controlling unit 15 makes the corresponding user log in the equipment. Subsequently, the processing proceeds to OP34.

If the processing Pk is File_open(U, X, H) (OP34: Yes), the processing proceeds to OP35. If the processing Pk is Remote_access(U, X, H1, H2) (OP34: No, OP36: Yes), the processing proceeds to OP37. If the processing Pk is File_copy(U, X, H1, H2) (OP34: No, OP36: No, OP38: Yes), the processing proceeds to OP39. If the processing Pk is neither of File_open (U, X, H), Remote_access (U, X, H1, H2) and File_copy(U, X, H1, H2), the processing proceeds to OP46.

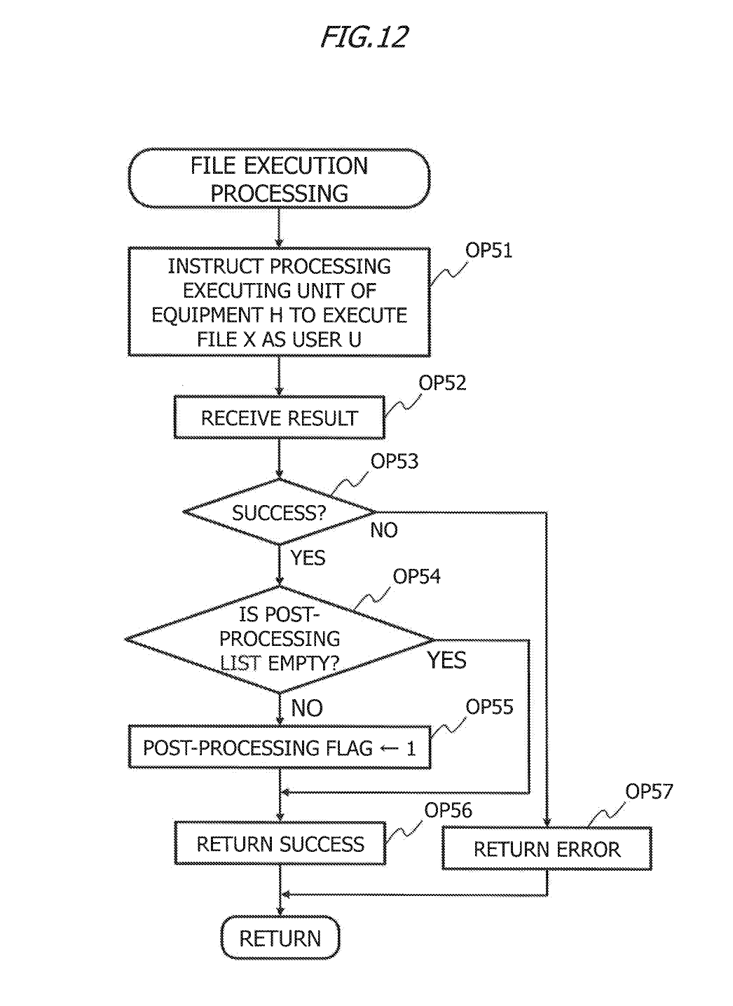

In OP35, because the processing Pk is File_open(U, X, H), the processing execution controlling unit 15 instructs the processing executing unit 33 of equipment H to execute the file X as the user U. “As the user U” means “using the authority of the user U”. The file execution processing will be described in details later in FIG. 12. Subsequently, the processing proceeds to OP41.

In OP37, because the processing Pk is Remote_access (U, X, H1, H2), the processing execution controlling unit 15 instructs the processing executing unit 33 of equipment H1 to remotely access the file X on equipment H2 as the user U. Subsequently, the processing proceeds to OP40. In OP40, the processing execution controlling unit 15 receives a processing result from the processing executing unit 33 of the equipment H1. Subsequently, the processing proceeds to OP41.

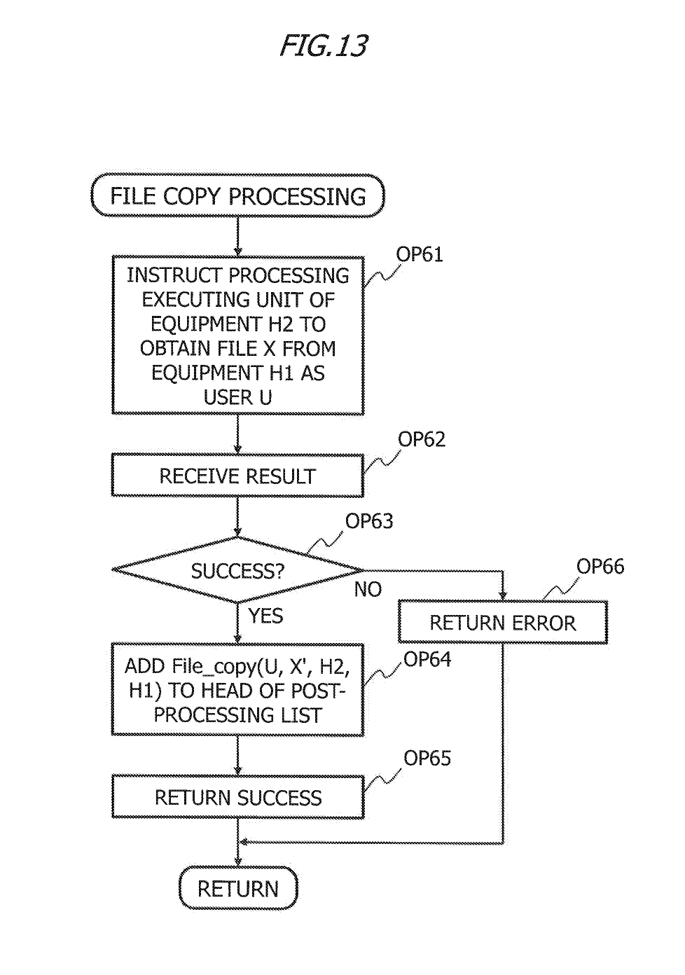

In OP39, because the processing Pk is File_copy(U, X, H1, H2), the processing execution controlling unit 15 executes file copy processing. The file copy processing will be described in details later in FIG. 13. Subsequently, the processing proceeds to OP41.

In OP41, the processing execution controlling unit 15 judges whether or not the execution result of the processing Pk includes a success of execution of the processing Pk. If the execution of the processing Pk succeeds (OP41: Yes), the processing proceeds to OP42. If the execution of the processing Pk fails (OP41: No), the processing proceeds to OP46.

In OP42, because the execution of the processing Pk succeeds, the processing execution controlling unit 15 sets a value of k+1 for the variable k. Subsequently, the processing proceeds to OP43.

In OP43, the processing execution controlling unit 15 judges whether or not the variable k is greater than m. If the variable k is greater than m (OP43: Yes), it indicates that all the processing included in the concretized processing procedure has been executed, and the processing proceeds to OP44. If the variable k is m or less, (OP43:No), because there is processing which has not been executed, the processing proceeds to OP33, and the processing from OP33 to OP42 is performed for the subsequent processing Pk.

In OP44, the processing execution controlling unit 15 judges whether or not the post-processing flag is 1, that is, whether or not the post-processing is executed. If the post-processing flag is 1 (OP44: Yes), the processing proceeds to OP45. If the post-processing flag is 0 (OP44: No), the processing illustrated in FIG. 11A and FIG. 11B is finished.

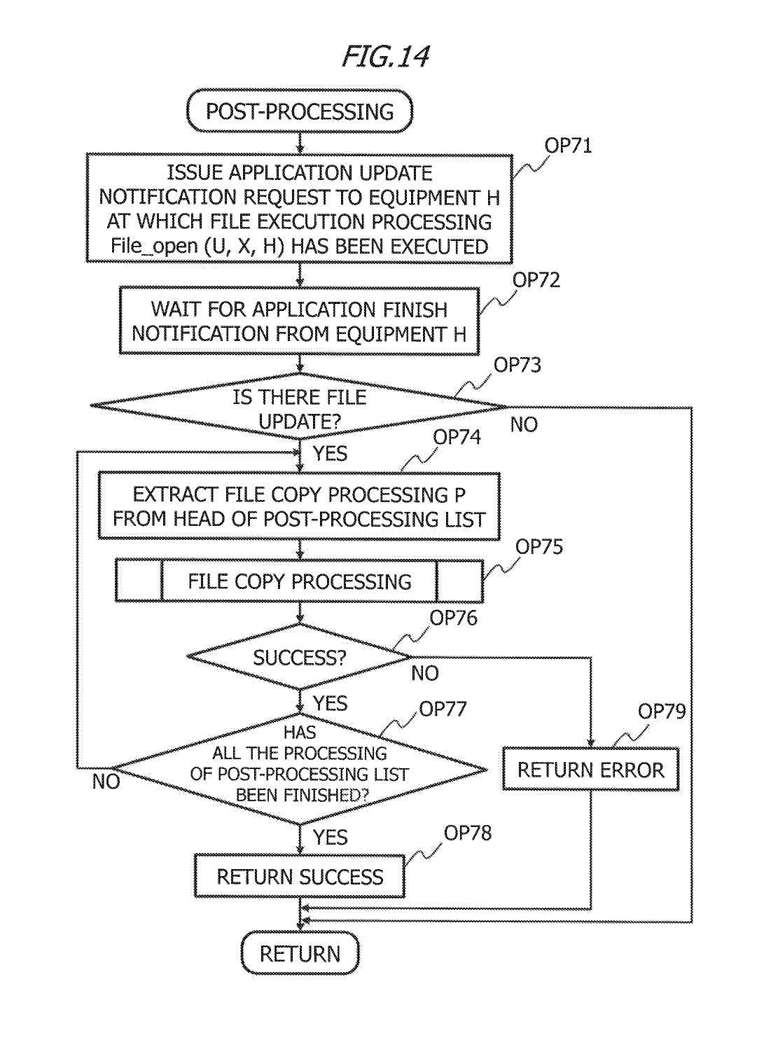

In OP45, the processing execution controlling unit 15 executes the post-processing. The post-processing will be described in details later in FIG. 14. After the post-processing, the processing illustrated in FIG. 11A and FIG. 11B is finished.

In OP46, because the execution of the processing Pk fails, the processing execution controlling unit 15 returns an error to the access source terminal 2. Then, the processing illustrated in FIG. 11A and FIG. 11B is finished.

FIG. 12 is an example of a flowchart of file execution processing. The file execution processing is processing performed by the processing execution controlling unit 15 when the processing Pk of the concretized processing procedure P is File_open (U, X, H) (the equipment H opens the file X on the equipment H using the authority of the user U).

In OP51, the processing execution controlling unit 15 instructs the processing executing unit 33 of the equipment H to execute the file X as the user U. Subsequently, the processing proceeds to OP52. In OP52, the processing execution controlling unit 15 receives a result from the equipment H. Subsequently, the processing proceeds to OP53.

In OP53, the processing execution controlling unit 15 judges whether or not the execution result of the processing Pk includes a success of the execution of the processing Pk. If the execution of the processing Pk succeeds (OP53: Yes), the processing proceeds to OP54. If the execution of the processing Pk fails (OP53: No), the processing proceeds to OP57.

In OP54, the processing execution controlling unit 15 judges whether or not the post-processing list is empty. If the post-processing list is empty (OP54: Yes), the processing proceeds to OP56. If the post-processing list is not empty (OP54: No), that is, the file copy processing has been performed prior to the processing Pk, the processing proceeds to OP55.

In OP55, the processing execution controlling unit 15 sets 1 for the post-processing flag. Subsequently, the processing proceeds to OP56.

In OP56, because the execution of the processing Pk succeeds, the processing execution controlling unit 15 returns a success and finishes the file execution processing illustrated in FIG. 12.

In OP57, because the execution of the processing Pk fails, the processing execution controlling unit 15 returns an error and finishes the file execution processing illustrated in FIG. 12.

FIG. 13 is an example of a flowchart of file copy processing. The file copy processing is processing performed by the processing execution controlling unit 15 when the processing Pk of the concretized processing procedure P is File_copy (U, X, H1, H2) (the file X on the equipment H1 is copied to the equipment H2 using the authority of the user U).

In OP61, the processing execution controlling unit 15 instructs the processing executing unit 33 of the equipment H2 to acquire (copy) the file X from the equipment H1 as the user U. Subsequently, the processing proceeds to OP62. In OP62, the processing execution controlling unit 15 receives a result from the processing executing unit 33 of the equipment H2. Subsequently, the processing proceeds to OP63.

In OP63, the processing execution controlling unit 15 judges whether or not the execution result of the processing Pk includes a success of the execution of the processing Pk. If the execution of the processing Pk succeeds (OP63: Yes), the processing proceeds to OP64. If the execution of the processing Pk fails (OP63: No), the processing proceeds to OP66.

In OP64, because the execution of the processing Pk succeeds, inverse processing of the executed file copy processing is added to the head of the post-processing list. The inverse processing of File_copy(U, X, H1, H2) which is File_copy(U, X′, H2, H1), means file copy from the equipment H2 to the equipment H1. Here, X′ is an identifier (URL) representing the file on H2 after the file X is copied. Subsequently, the processing proceeds to OP65, and, in OP65, the processing execution controlling unit 15 returns a success as the execution result of the processing Pk and finishes the file copy processing illustrated in FIG. 13.

In OP66, because the execution of the processing Pk fails, the processing execution controlling unit 15 returns an error and finishes the file copy processing illustrated in FIG. 13.

FIG. 14 is an example of a flowchart of the post-processing. The post-processing is processing executed when the post-processing flag is 1, that is, the file copy processing is normally performed, and all the processing included in the concretized processing procedure has been finished.

In OP71, the processing execution controlling unit 15 issues an application finish notification request for requesting the equipment H for which the file execution processing File_open(U, X, H) has been executed, to provide a notification as to whether or not file update is to occur. Subsequently, the processing proceeds to OP72, and, in OP72, the processing execution controlling unit 15 waits until the application finish notification is received from the equipment H.

The equipment H stores a final update time of the file at which the processing executing unit 33 starts the file execution processing and monitors the time until the corresponding application which executes the file is finished. When the corresponding application is finished, the processing executing unit 33 of the equipment H confirms a final update time of the corresponding file and compares the final update time of the corresponding file with the stored final update time. If the final update time of the file when the application is finished is later, the processing executing unit 33 of the equipment H judges that the file has been updated and transmits the application finish notification including information indicating that the file has been updated to the processing execution controlling unit 15 of the server 1.

In OP73, the processing executing unit 33 receives the application finish notification from the processing executing unit 33 of the equipment H and judges whether or not the application finish notification includes the information indicating that the file has been updated. If the application finish notification includes the information indicating that the file has been updated (OP73: Yes), the processing proceeds to OP74. If the application finish notification does not include information indicating that the file has been updated (OP73: No), the processing proceeds to OP79.

In OP74 and OP75, the processing execution controlling unit 15 which has been notified of file update, sequentially executes the inverse processing stored in the post-processing list in order of the list. The inverse processing stored in the post-processing list is file copy processing which is inverse processing of the file copy processing that has been executed before the file execution processing for which the update notification is requested in OP71.

In OP74, the processing execution controlling unit 15 extracts unprocessed inverse processing (file copy processing P) from the post-processing list. The file copy processing is extracted in order from the head of the post-processing list. Subsequently, the processing proceeds to OP75. In OP75, the processing execution controlling unit 15 executes the extracted file copy processing (see FIG. 13). By this means, the content of the updated file is reflected on the original file. Subsequently, the processing proceeds to OP76.

In OP76, it is judged whether or not the execution of the file copy processing P succeeds. If the execution of the file copy processing P succeeds (OP76: Yes), the processing proceeds to OP77. If the execution of the processing Pk fails (OP76: No), the processing proceeds to OP79.

In OP77, the processing execution controlling unit 15 judges whether or not all the invers processing in the post-processing list has finished. If all the invers processing in the post-processing list has finished (OP77: Yes), the processing proceeds to OP78.

If unprocessed invers processing is left in the post-processing list (OP77: No), the processing proceeds to OP74.

In OP78, the processing execution controlling unit 15 returns a success and finishes the file execution processing illustrated in FIG. 14.

In OP79, the processing execution controlling unit 15 returns an error and finishes the post-processing illustrated in FIG. 14.

Note that while omitted in the flowchart illustrated in FIG. 14, it is also possible to return a normal response or an error of the post-processing and return an error to the access source terminal 2 in the processing of FIG. 11A and FIG. 11B if the post-processing has failed.

By execution of the post-processing as illustrated in FIG. 14, for example, it is possible to edit the target file through access from the access source terminal 2, and, even if the content of the file has been changed, it is possible to reflect the change to the original file, so that it is possible to maintain consistency of the content of the file.

<Operation and Effect of the First Embodiment>

In the first embodiment, because the server 1 holds the abstracted processing procedure in advance, when access to a file is requested from the access source terminal 2, the server 1 creates a concretized processing procedure and instructs the corresponding equipment to execute the processing. By this means, a user of the access source terminal 2 can automatically sort appropriate processing to appropriate equipment by selecting a file to be accessed from a user interface. The user of the access source terminal 2 does not have to concern about a storage location of the target file, does not have to select equipment which will execute the processing or does not have to select a method for accessing the file him/herself. Therefore, according to the first embodiment, it is possible to improve convenience of access to a file stored in another equipment.

According to the information processing apparatus, the information processing system, the information processing method and the information processing program disclosed herein, it is possible to automate processing for accessing an electronic file stored in another device.

<Others>

In the first embodiment, while the server 1 also includes the remote access server 14 and the file transfer server 13, the present invention is not limited to this, and the server 1 does not have to include the remote access server 14 and the file transfer server 13. The remote access server 14 and the file transfer server 13 may be respectively provided at devices other than the server 1.

It is assumed in the first embodiment, that in the user equipment relation table 130, correspondence between the user identification information and the identification information of the equipment available to the user is stored, and each of the equipment A and the equipment B stored in the user equipment relation table 130 illustrated in FIG. 5B is associated with the identification information of a sole user. This is because the equipment A and the equipment B is equipment such as a smartphone and a tablet terminal, which assumes to be possessed by a certain individual, that is, the equipment A and the equipment B is equipment which assumes one user with respect to one equipment. In the case of such equipment, even if the server 1 or the system 100 does not perform user authentication, the user is authenticated by the equipment at the beginning of use of the equipment. Therefore, it is guaranteed that access from the equipment A and the equipment B illustrated in FIG. 5B is performed by a user having the identification information of the user associated in the user equipment relation table 130.

However, the equipment which can be used as the access source terminal 2 is not limited to equipment which is possessed by a certain individual as with a smartphone or a tablet terminal and for which user authentication is performed by the equipment at the beginning of use of the equipment. For example, a PC shared by a plurality of people at home, a PC shared by an unspecified number of people at an Internet cafe, or the like, can be utilized as the access source terminal 2.

If a PC shared by a plurality of people at home is utilized as the access source terminal 2, the PC and identification information of users (such as user names and authentication information) registered to the PC are registered in the user equipment relation table 130. Equipment C illustrated in FIG. 5B is such an example of the equipment. In the access request to the file from the PC, identification information of the equipment of the PC, identification of a user currently logging in the equipment and identification information of a target file are stored. The processing procedure configuration managing unit 16 of the server 1, for example, judges whether or not the identification information of the user stored in the access request matches any of the identification information of the users associated with the identification information of the equipment of the PC stored in the user equipment relation table 130 before starting the processing in FIG. 9A. By this means, it is possible to perform user authentication.

If a PC shared by an unspecified number of people is used as the access source terminal 2, user authentication is performed when access is performed from the PC. In this case, the server 1 includes an authenticating unit and an authentication table in which user IDs and passwords are stored, and the authenticating unit performs user authentication by judging whether or not a user ID and a password transmitted from the PC are stored in the authentication table. However, user authentication is not limited to this, and, for example, any user authentication method such as Public Key Infrastructure (PKI) may be used.

One of the other aspects of the present invention is an information processing system including the above-described information processing apparatus, the access source terminal and a device that holds an electronic file. Further, one of the other aspects of the present invention is an information processing method in which the information processing apparatus executes the above-described processing. Still further, the other aspects of the present invention can include an information processing program which causes a computer to function as the above-described information processing apparatus, and a computer-readable recording medium in which the program is recorded. The recording medium which is readable by a computer, or the like, is a recording medium in which information such as data and a program is non-transitory accumulated by electric, magnetic, optical, mechanical or chemical action, and the information can be read out from a computer, or the like.

All examples and conditional language provided herein are intended for the pedagogical purposes of aiding the reader in understanding the invention and the concepts contributed by the inventor to further the art, and are to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An information processing apparatus in a system which allows an access source terminal to access an electronic file held by another device, the information processing apparatus comprising:
a storage unit that holds a processing procedure for accessing the electronic file; and
a determining unit that determines an execution procedure for accessing a designated electronic file from an execution processing procedure corresponding to the processing procedure based on a size of the designated electronic file to be accessed and a state of an executing device of processing included in the processing procedure.

2. The information processing apparatus according to claim 1, wherein when receiving an access request to the designated electronic file from the access source terminal, the determining unit specifies the executing device of the processing included in the processing procedure based on the access request and obtains the execution processing procedure corresponding to the processing procedure.

3. The information processing apparatus according to claim 2, wherein the determining unit judges whether or not the processing included in the execution processing procedure corresponding to the processing procedure is executable based on the state of the executing device, and, when it is judged that all the processing included in the execution processing procedure is executable, determines the execution processing procedure as the execution procedure.

4. The information processing apparatus according to claim 3, wherein when there are a plurality of execution processing procedures for which it has been judged that all the processing is executable, the determining unit calculates cost of each execution processing procedure based on the size of the designated electronic file and attribute of a communication line and determines the execution procedure based on the cost.

5. The information processing apparatus according to claim 1, wherein
the storage unit holds a plurality of the processing procedures, and part of the plurality of the processing procedures includes copy processing of the designated electronic file; and
the determining unit obtains execution processing procedures corresponding to the plurality of the processing procedures, and, when a storage destination device of the designated electronic file is not remotely accessible, determines the execution procedure from the execution processing procedures including the copy processing of the designated electronic file.

6. The information processing apparatus according to claim 1, wherein
the storage unit holds a plurality of the processing procedures, and part of the plurality of the processing procedures includes processing of remote access; and
the determining unit obtains execution processing procedures corresponding to the plurality of the processing procedures, and, when the access source terminal does not have application which allows the designated electronic file to be browsed or edited, determines the execution procedure from the execution processing procedures including the remote access.

7. The information processing apparatus according to claim 1, further comprising:
a controlling unit that instructs each executing device to perform each processing included in the execution procedure according to the execution procedure,
wherein when the execution procedure includes the copy processing of the designated electronic file, the controlling unit instructs the corresponding executing device to execute processing of copying a copy file created by the copy processing to the designated electronic file again after all the processing included in the execution procedure is finished.

8. The information processing apparatus according to claim 1, wherein there are a plurality of the another devices within the system, and part or all of the devices have types and processing performance which are different from each other.

9. The information processing apparatus according to claim 1, wherein the processing procedure is in a state where an executing device for executing processing and an electronic file to be processed are not specified.

10. An information processing system comprising:
a plurality of devices that hold electronic files;
an access source terminal that accesses an electronic file held by any of the plurality of devices;
a storage unit that holds a processing procedure for accessing the electronic file; and
a determining unit that determines an execution procedure for accessing a designated electronic file from an execution processing procedure corresponding to the processing procedure based on a size of the designated electronic file to be accessed and a state of an executing device of processing included in the processing procedure.

11. An information processing method performed by an information processing apparatus in a system which allows an access source terminal to access an electronic file held by another device, the information processing method comprising:
holding a processing procedure for accessing the electronic file in a storage unit; and
determining an execution procedure for accessing a designated electronic file from an execution processing procedure corresponding to the processing procedure based on a size of the designated electronic file to be accessed and a state of an executing device of processing included in the processing procedure.

12. A non-transitory computer-readable recording medium recording an information processing program for causing a computer, in a system which allows an access source terminal to access an electronic file held by another device, to execute a process comprising:
holding a processing procedure for accessing the electronic file in a storage unit; and
determining an execution procedure for accessing a designated electronic file from an execution processing procedure corresponding to the processing procedure based on a size of the designated electronic file to be accessed and a state of an executing device of processing included in the processing procedure.
